(19) United States
(12) Patent Application Publication
(10) Pub. No.: US 2013/0303268 A1
(43) Pub. Date: Nov. 14, 2013

(54) System and Method for Fantasy Sports Draft and Operation

(71) Applicant: Pigskin Fantasy U, Inc., Dallas, TX (US)

(72) Inventor: Bradley Nathan Miller, Dallas, TX (US)

(73) Assignee: Pigskin Fantasy U, Inc., Dallas, TX (US)

(21) Appl. No.: 13/894,132

(22) Filed: May 14, 2013

Related U.S. Application Data
(60) Provisional application No. 61/646,717, filed on May 14, 2012.

(51) Int. Cl. A63F 13/12

(52) U.S. Cl. CPC A63F 13/12
USPC 463/25; 463/42

(57) ABSTRACT

A system and method enables operation of a game, such as a fantasy sports game. The system includes various software and hardware components such as one or more user stations, a network and a game platform. The game platform enables creation of a plurality of user teams. Each user team may include, for example, a plurality of real teams as its members. Performance of the real teams is monitored to determine relative performance of the user teams.

### TECHNICAL FIELD

The invention relates generally to fantasy sports games and, more particularly, to systems and methods for operating fantasy sports drafts, league formation, operation, game play, and the like.

### BACKGROUND

Fantasy sports games are generally known. A fantasy sport is a game where participants build a team of individual players selected from multiple teams in a league. The fantasy team competes against other fantasy teams based on the statistics generated by the real individual players or their real sports teams. Typically, the fantasy teams are made up of athletes in a professional sport. In some cases, statistical performance of the real players or real teams is converted into points that are compiled and totaled according to a roster selected by a manager that makes up a fantasy team. The point systems are typically simple enough to be manually calculated by a “league commissioner.” More complex systems use computer modeling of actual games based on statistical input generated by professional sports. In fantasy sports there is the ability to trade, cut, and sign players.

### SUMMARY

In general, various embodiments provide systems and methods for operating a fantasy sports program. The systems enable many aspects of the operation such as league formation, participant team formation, drafting, and execution of game play.

In one example embodiment a game system includes a host platform adapted to be connected to one or more user stations and operable to send and receive electronic information. The host platform includes one or more computers operable to execute one or more software modules. The host platform further includes one or more databases electronically connected to the one or more computers. A first software module is operable to receive a user team creation request from a user, present the user with a plurality of real teams, and accept from the user the selection of a plurality of the real teams as members of the user team. The host platform is operable to compare performance of at least two user teams.

In one example embodiment a game system is provided. The system has a host platform adapted to be connected to one or more user stations and operable to send and receive electronic information. The host platform includes one or more computers operable to execute one or more software modules. The host platform also includes one or more databases electronically connected to the one or more computers. A first software module is operable to receive user team creation requests from a plurality of users, present the users with a plurality of real team units, and accept from the users selections of a plurality of the real team units as members of the user teams. The host platform is operable to compare performance of at least two user teams.

In another example embodiment, a non-transitory computer readable medium has embodied thereon a program. The program is executable by a computing device for performing a method for operating a game. A first method step is receiving user team creation requests from a plurality of users. A second method step is presenting the users with a plurality of real team units. A third method step is accepting from the users selections of a plurality of the real team units as members of the user teams. A fourth method step is comparing performances of at least two user teams.

In another example embodiment, a method of operating a game is provided. A first method step is receiving, at a host platform, user team creation requests of a plurality of users, the requests being received from a plurality of user stations. A second method step is presenting, on at least one graphical user interface, a plurality of real team units for selection by the plurality of users. A third method step is accepting, at the host platform and from the plurality of user stations, selections of a plurality of the real team units as members of respective user teams. A fourth method step is comparing, at the host platform performances of at least two user teams.

### BRIEF DESCRIPTION OF THE DRAWINGS

FIG. 1 is a block diagram illustrating a system for operating a fantasy game according to an example embodiment;

FIG. 2 is a flow chart illustrating a method for operating a fantasy game according to an example embodiment; and

FIGS. 3-27 are graphical user interfaces illustrating portions of a fantasy game according to an example embodiment

### DETAILED DESCRIPTION

According to various embodiments, a system is provided for operating a fantasy sports game. The system includes a number of different hardware, software, and networking components to enable the various functionalities associated with the game. It has been recognized that there are several shortcomings of current fantasy sports games. For instance, current games are based on fantasy teams that are composed of a plurality of individual, real sports players, rather than being composed of a plurality of real teams. Also, current games typically involve professional sports rather than collegiate sports. One reason for this is that there are too many collegiate sports teams and too many collegiate leagues and divisions in order to operate fantasy sports games based on teams comprising individual players. Various embodiments described herein address some, none, or all of these shortcomings.

In certain embodiments, a fantasy game is provided in which a fantasy team is composed of a plurality of real teams. According to certain aspects, the real teams that make up a fantasy team may be real collegiate sports teams. The description refers to collegiate football as the environment for the operation of the fantasy sports game. However, it should be understood that the fantasy sports system described herein may be used in any sports environment, including professional, amateur, collegiate, men's, and women's sports, and sporting environments broken down according to other factors. Any sporting type may be utilized including, for example, football, basketball, track, baseball, softball, soccer, and the like. Also, the functionality of the system described herein may be applied to other activities that might not be viewed as sports, such as competitions associated with reality television programming. This might include, for example, dating contests, talent contests, survival contests, and the like. Preferably, the sports or non-sports event providing the basis for the game is a team-type competition such that a user team may be made up of one or more real teams.

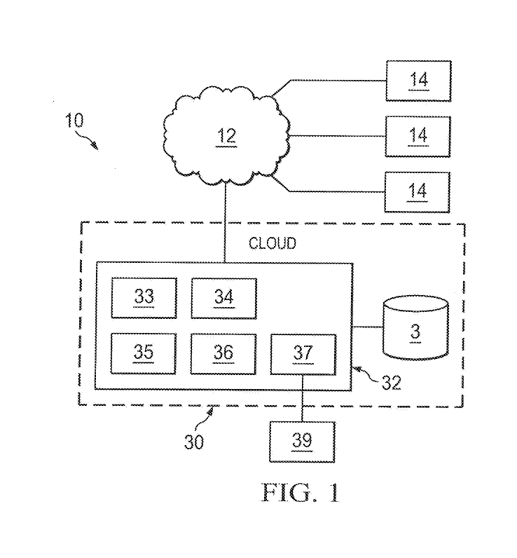

As shown in FIG. 1, for example, a system 10 is provided for operating a fantasy sports game. System 10 includes a number of different components, which will be described in further detail. One or more of the components may comprise hardware and/or software. The components are operable to communicate with one another. The communication between components may be conducted over any suitable existing, or future, telecommunication path employing any suitable existing, or future, telecommunication technology. For example, telecommunication may occur over one or more communication networks employing one or more technologies such as wide area networks, local area networks, virtual private networks, metropolitan area networks, etc. The communication may employ any suitable protocol including, without limitation, transmission control protocol, internet protocol, hypertext transfer protocol, file transfer protocol, and the like. Other technologies may be employed such as Wi-Fi, Bluetooth, cloud computing, etc. The communications may employ cellular, wireless, land lines, cloud computing and other technologies. Information may be transferred using any known switching and data transfer technologies.

System 10 includes one or more user stations 14 connected to game platform 30. The connection may be accomplished via a network 12. It should be understood that the connection between components may be according to any suitable known or future connection involving networking, telecommunications, data transmission, and the like. It should also be understood that various embodiments may include multiple user stations, computers, servers, databases, processors, and other components interconnected according to any suitable configuration that allows the functionality of the game to be executed.

User station 14 can be any type of suitable user device that provides connectivity to network 12 and the game platform 30. Thus, user station 14 can be a computer, server, Internet-enabled device, television, smart book, notebook, laptop, desktop, smartphone, telephone, mobile phone, kiosk, interactive game station, handheld gaming device, etc. Game platform 30 may comprise any suitable computer such as, but not limited to, computers, personal computers, desktops, laptops, notebooks, smart books, servers, and the like.

Game platform 30 comprises one or more computers 32 capable of executing various software programs and modules 33-37. Game platform 30 may also include one or more databases 38 for storing information associated with the services it provides. The computers may include any suitable type and the term “computer” is not intended to be limiting as to any particular type of computing platform or processor. Similarly, any suitable databases may be employed and the term “database” is not intended to be limiting as to any particular type of database. The one or more computers and databases may be linked together in any suitable manner using any known, or future, computer networking technology. Other components within system 10 may also comprise one or more computers and databases and those components may likewise use any suitable computers and databases that are connected using any known, or future, networking technology.

User stations 14 are operable to contact computer system 32 to request information associated with the account of the respective user participating in a fantasy sports game. Computer system 32 may, in turn, retrieve the requested account information from, for example database 38. For example, a user that would like to create a fantasy team may make that request at user station 14. The request may be made, for example, by clicking on one or more appropriate tabs of a graphic user interface presented on a web page of a website supporting the fantasy sports game. User station 14 may, in turn, connect with one or more host servers hosting the various components of game platform 30.

Game platform 30 may determine a variety of information associated with the identified account. This information may include, without limitation, one or more names, identification numbers, passwords, or other identifying data associated with the account, an account balance, account availability, other accounts linked to the particular account, and any other information such as account holds, fraud alerts, etc. Game platform 30 may, for example, determine that the account selected by the user is properly associated with the password entered by the user and is available to transact game actions. Game platform 30, for example, may inform user station 14 that the user identification is valid and that user station should accept a user request to establish a new fantasy sports team.

One or more modules 33-37 enable the operation of the various game actions. These actions may include, without limitation, any, some, or all of the following:

Formation of one or more leagues. A league may include multiple user teams. These user teams may be aggregated, separated, divided, ranked, etc. according to any desired game structure. Thus, the league, for example, may be broken down into conferences, divisions, user abilities, etc.

Formation of user teams. A user team preferably comprises a plurality of real sports teams. Thus, for example, a user team might include five real, collegiate football teams. Alternatively, a user team might comprise a plurality of groups of teams. For example, a user team might include multiple collegiate football conferences. A user may be presented with a set of real sports teams from which to choose. The set of real teams may be a subset of all of the real sports teams in a real sports league. For example, the set of sports teams presented to the user might be all of the Division 1 collegiate football teams. The game may utilize a draft system as part of the process for creating leagues and/or teams. The draft may function according to any number of desired parameters and processes. For example, draft positions may be determined according to prior user team performance; random draft order; user team newness; prior activity of a given user; credits, points, and/or payments; real team characteristic, parameters, types, statistics, rankings, etc.; and the like.

Trading. A user may be able to trade one or more of the real teams on his user team for one or more real teams on another user's team. A user may also trade one or more of the real teams on his user team for other real teams that have not been drafted. These other, undrafted teams may be referred to, for example, as “free agents.”

Performance monitoring. The system keeps track of the performance of real teams throughout a specified period. Depending on the purpose for the performance monitoring, the specified period may be the duration of one or more games, a period of days or weeks, all or part of a season or post-season, etc. The system also monitors the performance of the user teams. Performance may be based on any of a number of criteria, or upon a combination of criteria. According to one aspect, performance is based on the win/loss record of the real teams making up a given user team. In other embodiments, performance may be based on wins or losses; points; benchmarks; percentages; statistics; spreads; odds, and the like.

Other actions. The system may allow other actions such as, for example, communication between users; research regarding other users, fantasy teams, real teams, etc.; system preferences; account creation and monitoring; payments; advertising; gambling; and the like.

At least one of the modules, illustrated as module 37 in the example shown in FIG. 1, is operable to receive information from a data provider 39. Module 37 may comprise an ftp (file transfer protocol) module or any other suitable component for receiving data from a data source. Data provider may be an independent or third-party data provider that provides data relevant to the activity on which the fantasy game is based. For example, data provider 39 may provide data concerning scores, schedules, injury reports, news feeds, wins, losses, statistics, and the like.

According to one example embodiment, system 10 provides for the creation of one or more fantasy leagues. As described herein, the fantasy game play will be considered in connection with NCAA college football. However, it should be understood that some or all embodiments may be applied to other types or sports, other levels of sports, and other activities altogether. For instance, certain embodiments may provide fantasy game play based on professional or amateur sports, major or minor leagues, clubs sports, recreational leagues, and all of the various divisions within any of these leagues. Certain embodiments may be applied to any suitable team sport, such as football, baseball, basketball, baseball, soccer, etc. Certain embodiments may be based on individual sports, such as bowling, golf, or horse racing for example. Hybrid sports, such as swimming, auto racing, or cycling may also be used, where some participants are individuals and some participants are teams. Certain embodiments may be applied to non-sports activities such as reality television events and their associated activities.

In one embodiment, a plurality of fantasy leagues is created. The leagues may be public, where any user, or a certain group of users, is approved for participation. The league may be private where only certain users may participate. The leagues may automatically allow users to participate, or an application process may be involved whereby a user applies to participate and a determination of whether that user may participate is made by comparing information in the application to one or more predetermined criteria.

A league may be pre-formed by a system operator such that users only create teams to participate in the league. Optionally, a league may be established by a user and teams within that league may be established by the same user and other users.

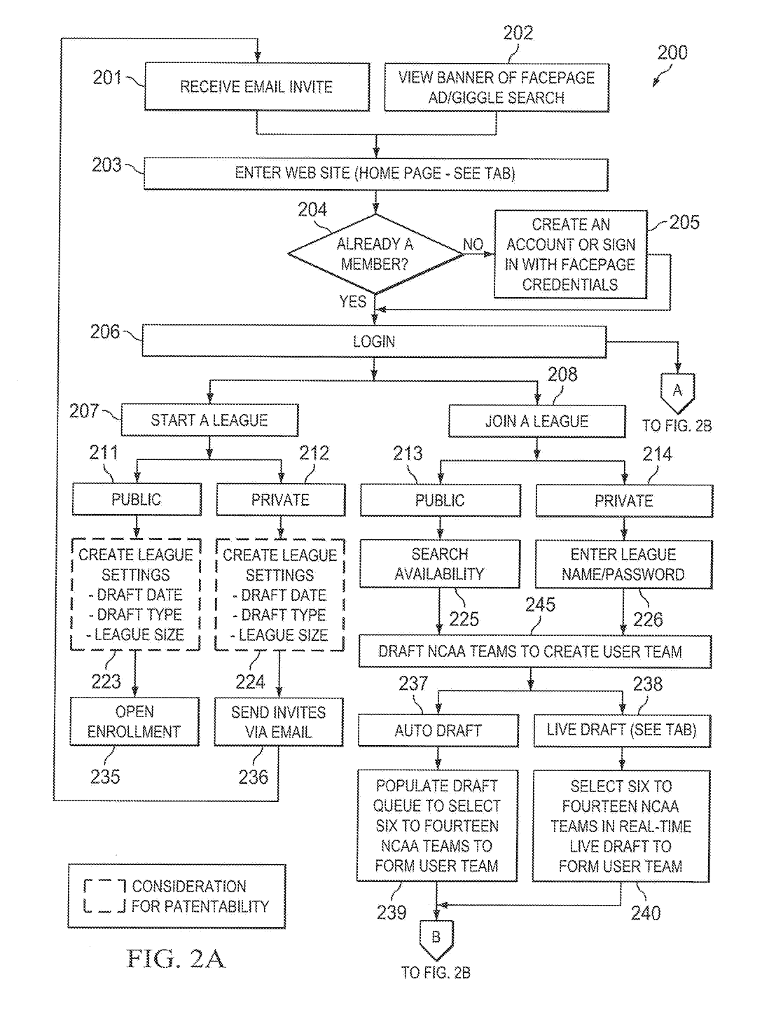

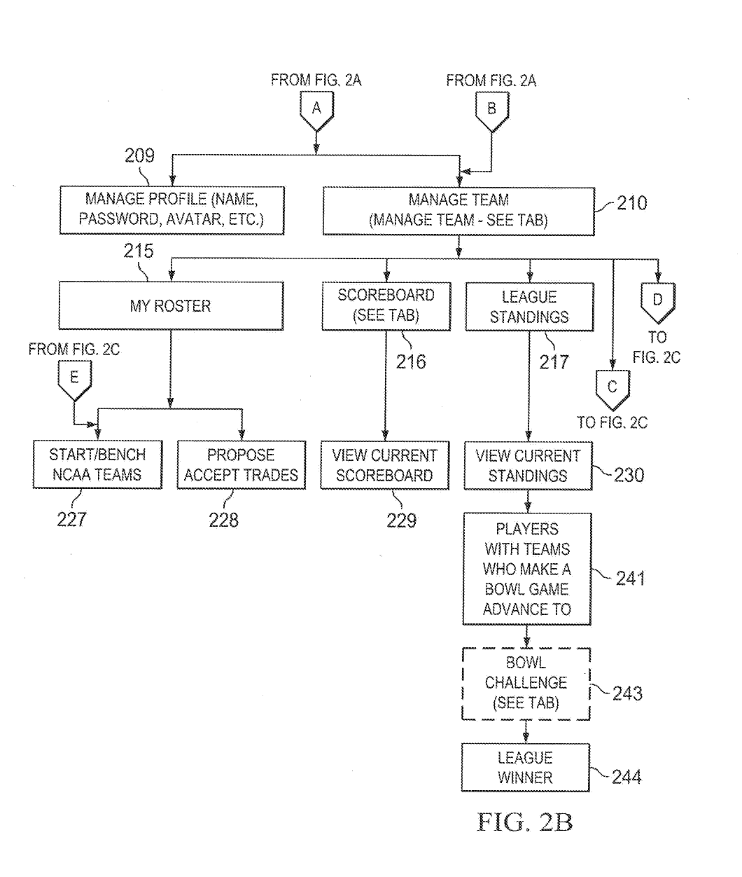

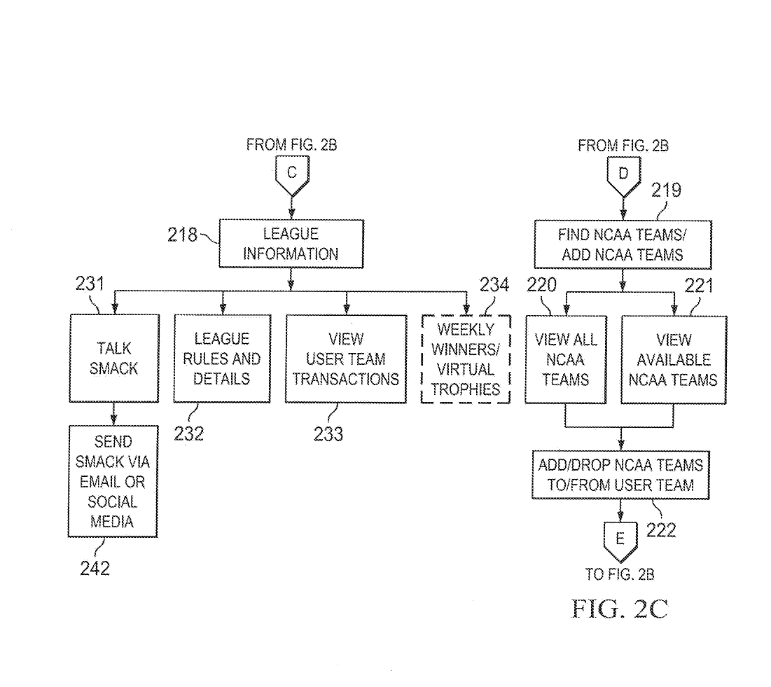

User activity may be illustrated in connection with the flow chart at FIG. 2. The flow chart illustrates a process 200 for creating, conducting, and operating a fantasy league. Again, it should be understood that the functionality illustrated and described herein may be applied to any suitable fantasy game. FIG. 2 illustrates a specific example concerning operation of a fantasy sports game based on college football. It is in no way intended to be limited as such. The functionality described and illustrated in the example, as well as in other example embodiments described herein, may be employed in other scenarios including other sports games, other non-sports games, and other activities. Preferably, the systems and methods described herein are applied to fantasy activities that involve fantasy teams and groups of teams. Although FIG. 2 illustrates a number of steps, it should be understood that different embodiments may include some, none, or all of the steps identified in FIG. 2. Also, the order of steps shown in FIG. 2 may be changed as desired.

At step 201, a user initiates activity by, for example, accessing the website for the fantasy sports game in response to an Email invitation. Emails may be sent to any number of potential participants according to any number of criteria. The criteria used, and the participants invited by Email depends on a variety of factors including marketing objectives and target markets. Alternatively, a user may initiate activity in response to an alternated portal such as an advertising banner that the user views on a web page, or by clicking a link that the user may have found by conducting an Internet search or that the user has otherwise viewed on a computer network, such as the Internet.

At step 203, the user accesses a web site, which is a portal for the hosted fantasy sports game. The web site may represent a user interface for a user to access the various functionality of the game and to otherwise participate in league play. It should be understood that in alternative embodiments, step 203 may represent a user accessing the fantasy sports game, and/or the game platform via any suitable communications network. This may include the Internet, mobile and landline telecommunications networks, and/or any network that can allow access to the game, such as (for example) those described elsewhere herein. The access may be achieved over any of such networks or combinations of such networks. In an Internet/web page-based configuration, a user may be directed or redirected to the web site hosting the game.

Once the user is at the game web site, the user may be presented with any number of authentication, qualification, and verification prompts. At step 204, for example, the user is asked whether he or she already a member. For example, users that are already members may have prior registration data saved on a database that enables the system to interact with the user without going through some of the steps that a new user might need to take. For instance, those users who are already members might have identification data, financial data, prior league and game play data, preferences, and so forth already stored on a database or on some other memory platform which is either part of the system or which the system may otherwise access. This information can be used to allow the user to conduct activity on the web site.

At step 205, the user may create an account, for example, if the user is not already a member. Of course, a user that is already a member may be able to create a new account at step 205. Optionally, the game platform may be configured to take steps to prevent, or minimize the chances, that an already-existing member creates a second account. During account creation, the user may be queried according to any number of criteria and may be asked to provide input for any number of suitable data fields. One or more of these data fields may be used by the system to enable the user to conduct game play. The information collected from the user may include, for example, personal data such as name, address, personal identification numbers, telephone numbers, email addresses, Twitter® accounts, Facebook® accounts, other Internet account information, sex and ethnicity information and the like. The information may also include financial data, such as a user's bank account information, credit card data, social security information and the like. The information may also include any other information to enable the functionality of the gaming platform. For instance, the information may include referral information associated with other users or potential users that have referred the user to the web site. The information may also include survey and marketing information. During account creation, the user may be prompted to create additional information such as login information like a username and password.

If it is determined at step 204 that the user already has an account, or the user has now created an account at step 205, then the user may be directed to a login procedure at step 206. At step 206, the system checks the login information against stored information for that user. If there is a match, then the system allows the user to proceed to league and game activity. If there is not a match, then the system may return the user to step 205 for account creation or may direct the user to an information recovery procedure by which the user may find missing, lost, or forgotten information. According to the information recovery procedure, the user may, for instance, indicate that he has lost his password. If so, then the user may request a password reset. Optionally, an already-existing password may be sent to the user via, for example, Email. This might be done, for example, if the user correctly answers one or more security questions. Once the user has correctly established an account, remembered or recovered the login information, and properly logged in, then the user is allowed to proceed to league and game activity.

Once the user has properly accessed the system and logged in, the user is presented with at least four basic options: (1) start a league; (2) join an already-existing league; (3) manage a user profile; or (4) manage a team or league. Other options may be made available to the user at this point, or other points, in the process.

At step 207, the user may conduct activities associated with creating a league. The user can elect to create a public league at step 211 or a private league at step 212. A public league is open to all participants or a subset established by the operator of the game, web site, etc. Therefore, the public league is open to participants that may or may not have some relationship with the user creating the league. A private league is open only to participants identified by the user creating the league. Thus, the league creator can establish a league of select participants (e.g., friends, family, co-workers, etc.). If the user creating a league elects a public league, then, at step 223, the user establishes league settings. The league setting may be any suitable criteria for operating a fantasy sports game. This can include, for example (and without limitation), league size, draft date and time, draft type, etc. Any of the league settings may be limited, as desired, by the game platform owner or operator. League size in the illustrated example means the number of participant teams allowed in the league. In other contexts, as in other embodiments, league size may have other meanings such as number of players, geographic area, age groups, etc. Draft type in the illustrated example means whether the draft will be conducted online or offline. Online generally refers to an electronic draft, which may be conducted over a data communications network, such as the Internet. Offline drafts can be conducted in a number of different environments such as in-person, or over a telephone conference call. Draft type may have other meanings in this embodiment or other embodiments. For example, draft type may refer to the manner in which the draft order is selected, initiated, and/or perpetuated during the draft. For example, a first draft choice may be established at random or according to some other predetermined criteria such as prior performance, prior win/loss record, personal criteria, alphabetically by participant, age, selection by the league creator, first user to establish a team within the league, etc. The remaining draft order may be established by the same criteria or different criteria. In one example, a snake or serpent draft may be employed, according to which the draft order is followed for one round and then reversed for another round. Any suitable draft structure may be employed. The user creating the league may also, in certain circumstances, be able to dictate the type of game play to be followed for the league. Examples of different game types are described elsewhere herein. The user creating the league may also be able to establish criteria for league participants to create teams and select units for those teams. The term “units” is meant to indicate the components of a team. In certain example embodiments, the components are real athletic teams, or groups of individual athletes. At step 235, the league is established and is made available for open enrollment by other users.

If the user creating the league elects to create a private league, then, at step 224, the user can establish the same or different league criteria as already described in connection with public leagues. At step 236, the private league is established and made available for enrollment. The league creator may be allowed to notify the anticipated league participants by, for example, Email. Invited participants may be required to present credentials at some point in the joining process to ensure that they are joining the right league and that they, in fact, have been invited to join the private league.

At step 208, a user that has properly logged on may select to join a league. The user may be presented with an initial decision to join a public league or a private league. At step 213, a user joins a public league. At step 225, the user is presented with a search option according to which the user may search all of the available leagues for the public league he or she wishes to join. The search may employ one or more search filters to assist the user in identifying a league that meets the user's preferences. These filters may be based on any number of criteria including, without limitation, league size, team size, activity type (e.g., football, basketball, and etc.), actual leagues from which units will be drafted, information concerning already-existing league participants, league type (e.g., public or private), commissioner (e.g., league creator), name, draft date and time, draft type, etc. Preferably, the user is presented with a list of leagues that meet the user's preferences, and the user selects a league to join. If the user selects a private league from the list, the user may be redirected to a private league selection process described in connection with steps 214 and 226. At step 214, a user may elect to join a private league (e.g., in response to an Email invitation from a private league creator). At step 226, the user may be required to present certain validating credentials to aid the system or operator in entering the user in the correct league and/or ensuring that the user is, in fact, an appropriate invitee. The credentials in the illustrated example include league name and password (e.g., a password provided to the user from the league creator). Other credentials may be employed. Although not expressly illustrated, the system may present the user wishing to join a private league with a search process like that described in connection with users wishing to join a public league.

At step 245, a draft is conducted. Preferably, the draft is conducted after all of the available user team spots have been filled. For example, if a league is established with a league size of 6 teams, then the draft is not conducted until users have joined the league. However, in certain circumstances, it may be desirable to conduct the draft, or begin the draft, prior to all league team slots being filled. The draft involves each participant drafting units for their respective participant teams. In the illustrated example, users draft NCAA college football teams as units for the participant teams in the fantasy league. In other words, a fantasy game participant team is made of units, each unit being a real college football team.

The draft may be an auto draft, or a live draft. At step 237, auto draft is selected. Auto draft refers to a draft technique according to which a participant selects a number of units and those players are placed into a draft queue. The draft then proceeds automatically with units in the user's queue either making it onto the user's “team” or being selected by another participant and thus being removed from the first user's queue. At step 238, the user can elect a live draft process. Live draft refers to a draft process whereby the user forming his or her team drafts available units from the unit pool in real time as their turn comes up in each round of the draft. The user may be able to elect what type of draft process they want to use, or they may be required (e.g., by the league creator) to use one particular type of draft process.

At step 239, an auto draft is conducted. The participant “teams” are filled as the draft rounds proceed and units from those still available are placed on the respective participant “team” according to the selections in, and order of, the participant's auto draft queue. As already indicated, once a unit has been placed onto a “team,” that player may be removed from other participant draft queues or otherwise be made unavailable to be placed on another participant “team.”

At step 240, a live draft is conducted. The participant “teams” are filled as the draft rounds proceed, and units from those still available are selected in real time by the respective participants and placed on those respective participants' “teams.” Once a unit has been placed onto a “team,” that player may be removed from the available unit pool, or otherwise be made unavailable to be placed on another participant “team.”

It should be noted that undrafted units, or units that have been removed from a “team,” are available as “free agents.” Free agent units may be drafted by any participant, or by certain participants based on approval or other qualifications.

Once the teams have been created and the league has been formed and filled out, the league and/or teams may be made available for management. Management may be conducted by a team manager, a league manager, a system operator, or another entity, or automatically by one or more software modules. Management may be ad hoc or automatic. Management may be conducted according to one or more predetermined rules. In at least one embodiment, management of the team is conducted by the participant that created the team. In other words, that participant can take actions with respect to the “team” he or she created. Team management is discussed in greater detail below.

At step 209 a user may elect to manage their user profile. According to this sub-process, the user may add, delete, or modify any number of criteria depending on the permissions granted by the system or system operator. For example a user profile may include any of the user information already discussed such as, for instance, passwords, identification data (e.g., avatars, images, usernames, etc.), personal data, financial data, and the like.

At step 209 a user may elect to participate in team management activities. Preferably, a user may only manage a team that was created by or for that user, or which the user is otherwise responsible for managing. Initially, the user may elect one of five management options including: (1) roster management; (2) scoreboard; (3) league standings; (4) league information; or (5) real team (e.g., fantasy unit information). The available management options are illustrative only and are not intended to be limiting. Other management options may be available and presented to the user. Management activities may be presented via one or more GUIs, portals, web pages, etc. to one or more users. In some cases, activities associated with different management options may be presented to a user on the same GUI, portal, web page, etc.

At step 215, the user selects, and/or is presented with, “roster management” activities. Roster management involves actions pertaining to the user's participant “team.” The illustrated embodiment reflects (1) starting and/or benching real teams on a user's roster, and (2) accepting, rejecting, and/or proposing trades. The roster activities, however, are not so limited and can include any activity associated with additions to, deletions from, and/or modifications of the roster for any suitable purpose.

At step 227, the user selects an option to set a lineup. The lineup is set by starting and/or benching real teams that are on the user's team. A real team (i.e., virtual unit) may be made part of a lineup for a predetermined period, for example. For instance, if a predetermined period corresponded to a period of time in which all real teams played (such as one week in college football), then the user is enabled to establish a lineup for that coming week. The user adds real teams from his roster to the lineup. The user may also be enabled to delete teams from the lineup or otherwise change teams on the lineup. The user may be further enabled to establish lineups for multiple ones of the predetermined periods. For example, the user may be able to establish lineups for college football play for two or more weeks of a season of college football. Restrictions may be placed upon the user in terms of establishing the lineup. For example, according to one aspect, the user may have to remove a certain number of teams from the lineup that have played in a prior predetermined period or that have met, or failed to meet, some predetermined performance criteria. Adding real teams to the lineup may sometimes be referred to as “starting” the real teams or “virtual players.” Deleting real teams from (or failing to add them to) the lineup may sometimes be referred to as “benching” the real teams or “virtual players.”

At step 228, a user may propose and/or accept trades. Trades may be executed according to any suitable process. According to at least one embodiment, in order to effect a trade, one user proposes a trade. The trade proposition may include a proposal to trade a real team on the first user's roster for a real team on a second user's roster. The first and second user may be, for example, in the same league. In certain cases, it may be desirable to have proposed trades go through an approval process. For example, the system may be configured to require a proposed trade to be approved by one or more entities such as a league commissioner, system operator, and or a particular user or group of users. Once the trade proposition is approved, it is presented to the second user (i.e., target user). The second user can then accept or decline the trade. Alternatively, the second user may initiate a response proposition and/or modify the first user's trade proposition. The response or modification may be presented to the first user and may also go through an approval process.

At step 216, the user selects, and/or is presented with, “scoreboard” activities. With scoreboard activities, the user may view information associated with the user's team performance and/or the performance of real teams (units) on his or her user team. In some cases, the user may be able to view the same type of information associated with other user teams either in the league or in another league. Scoreboard information can include, but is not limited to, win and loss information for games that the real team units have played. This can include an indication of the period of play such as, for example, which week during a college football season was the real game played. The scoreboard information can also include the score of any real game, identification of the opponent, identification of the user and/user team that has either of the real teams on his or her roster, and identification (dates, times, names, locations, etc.) of future matches between the real teams. Scoreboard information may also include current status information associated with the real games such as whether a game is pending, being currently played, or has been played. Scoreboard information may also include odds and line information, and other similar information associated with sports betting. Scoreboard information may also include information identifying whether a team will play, or will be in a “bye” situation, for any given time or time period (such as, for example, during a particular week of a college football season). Scoreboard information may be presented in any number of formats. This may include a presentation of the information for all real teams, all real teams in a league, or the real teams on a particular user team. The latter may be further broken down into active (starting) and/or benched real teams. Scoreboard activities may also include enabling a user to make notes regarding the scoreboard information. At step 229, a user may view a scoreboard, which may include some, none, or all of the information described above in connection with scoreboard activities.

At step 217, the user selects, and/or is presented with, “league standings” activities. “League standings” activities may include anything associated with viewing, manipulating, changing, etc. information associated with league standings. At step 230, for example, a user elects to view the current league standings. The information presented to the user at this point may include information similar to the scoreboard information. In some cases, the scoreboard information may be limited to information associated with the performance of real teams (units) on the rosters of those user teams that are playing, or have played, in a specified predetermined period. For example, week 5 of a college football seasons may be selected, and scoreboard information may be shown for the user teams that played during that week. Thus, scoreboard information for that week would include identification of the starting and/or benched real teams (units) of the user teams, their opponents, the scores of the real games, win and loss indicators, etc. Whereas “league standings” information might include some or all of this scoreboard information, “league standings” information may also include overall standings as of a certain time (e.g., the end of week 5 of the college football season). This information may comprise, without limitation, identification of the user teams within the league, indications of divisions within the league to which the user teams belong, win and loss indicators and/or totals, win and/or loss rates or percentages, an indication of how many games a user team is behind the leading user team, win and/or loss streaks, and upcoming opponent information.

It should be noted at this point that information displayed in connection with scoreboard activities, league standing activities, or in connection with other activities supported by the system, may be based on actual real team performance such as actual play between real teams. Performance of the user teams may be qualified, quantified, and assessed according to different rules and different types of fantasy game structure. According to one embodiment, user teams participate in periodic head-to-head competition. The competition may pit one user team against another user team for a predetermined period (e.g., one week during college football season). Which user teams will be pitted against which other user teams may be preselected (e.g., by decision of a league commissioner), on a rotating basis (which itself may be determine according to any number of preset rules), or by some other suitable method. In head-to-head play, for the defined play period, a first user team will “play” against a second user team. The performance of these two user teams will be determined by the performance of the real teams on those user teams during the predetermined time period. While two user teams are pitted against each other for a given time period, two other user teams may be pitted against each other for the same time period. Thus, it is preferred that the league comprises an even number or user teams. However, the system and methods may be configured to accommodate an odd number of user teams. For example, in a league having an odd number of user teams, each user team may be assigned a “bye” period during which that user team does not compete.

Alternatively, game play may follow a one-against-plurality format. Accordingly, for a given predetermined time period, one user team is pitted against more than one other user team. Again, the user teams pitted against each other for the respective time periods may be rotated so that a given user team plays at least one different user team each play period and, preferably, plays all of the other user teams in the league during the season of play.

Alternatively, game play may follow a one-against-all format. Accordingly, for a given predetermined time period, one user team is pitted against all the other user teams. Thus, for each time period in a season of play, all user teams are playing against all other user teams.

At step 241, a user may advance to post-season information and/or post season play. Similarly, as the post season progresses, the user (e.g., the user's team) may advance to different levels of post season play. For example, in the college football context, user teams may advance to bowl challenge play and bowl championship play in steps 243 and 244, respectively. Post season performance may be determined according to a number of criteria. In one alternative post season format, for example, comparison of the performance of user teams encompasses comparing performance of a first user team during post season play of the real team to a performance of a second user team during the post season play. The comparison may further include awarding at least one point for a real team appearing in a post season game. This is optional, however, and the system may be configured to award points only for wins in post-season play. Thus, the comparison may further include awarding at least one point for a real team winning a post season game. According to one example scenario, the real teams are real college football teams and the comparison among user teams involves awarding one point for a real team (unit) winning a post season game, awarding one point for a real team (unit) appearing in a Bowl Championship Series bowl game, awarding two points for a real team (unit) winning a Bowl Championship Series bowl game, and awarding three points for a real team (unit) winning the Bowl Championship Series.

It should be noted that these are examples of game play structure. Other suitable structures may be employed as desired. The number of points awarded may be different for different win and/or loss instances. Also, it is not necessary to award points for every instance or advancement described.

At step 218, the user selects, and/or is presented with, “league information” activities. “League information” activities may refer to any activities concerning interaction with any live or virtual entity associated with the league that a particular user is in, or with another league or user in another league.

For example, at step 231, a user may initiate electronic communications with one or more other users. And, at step 242, the user may send the electronic communications to the one or more other users. The electronic communications may include communication pertinent to the performance of user teams or real teams. For example, the communications may comprise what is known as “smack talk.” The system, or a user, commissioner, system operator, or some other entity, may evaluate the electronic communications. The communications may be assigned a quality rating and certain actions may be undertaken that relate to the quality rating. For instance, penalties may be assessed on, or rewards granted to, users based on the quality and/or content of their electronic communications. The assessment may be objective, subjective, or some of both.

At step 232 a user may view league rules and/or details. This may include, but is not limited to, any of the various league information or associated information described elsewhere herein and/or links to such information.

At step 233, a user may view team transactions. The transactions may involve the user's team or teams of other users. Team transactions may include any modification of a user team including selection of starting “players,” benching of “players,” electronic communications, performance indicators, rewards and awards, changes in rankings, statistics, trades and proposed trades, trade approvals, and the like.

At step 234, the system may present and/or a user may view periodic award recipients, rewards, virtual trophies, rankings, and the like.

At step 219, the user selects, and/or is presented with, “real team information” activities. At step 220, the user may view all of the real teams in the pool from which the various leagues and user teams are created. In step 221, alternatively, the user can view all available real teams. “Available,” in at least some embodiments, may be defined to mean available for addition to a user team. Thus, “available” may mean that the particular real team is in the system pool of real teams and has not yet been drafted by a user within the same league as the user viewing the available real teams. Thus, the user reviewing the listing of available real teams might draft an “available” real team, add that “available” real team to his or her draft queue, or otherwise select the “available” real team. It should be noted that the real teams may be filtered according to additional criteria beyond “available” or “unavailable.” Any suitable criteria may be used to filter the real teams being viewed including, but not limited to, real team statistics, prior user team makeup, penalties against or rewards to a user team (e.g., certain real teams may be made available or unavailable to a subset of the users within the system or within a league), etc. At step 222 the user may add or drop real teams from his or her user team.

It should be noted that certain steps may be accomplished automatically. Thus, for example, awards, points, rankings, win/loss indications, etc. may be established or granted automatically by one or more modules of the game platform in response to receiving data regarding the games. Such data may be received from, for example, a data provider. For instance, the game platform may receive data from a data provider and may automatically transform that data to one or more indicators for one or more user teams. The indicators may be points, rewards, money, prizes, rankings, win/loss indicators, user team statistics, etc. For example, if a real team wins and the data provider provides data to the game platform indicating that the particular real team won, then the game platform may transform that “win” data to a “plus one win indicator” for all user teams in the system that have that particular real team.

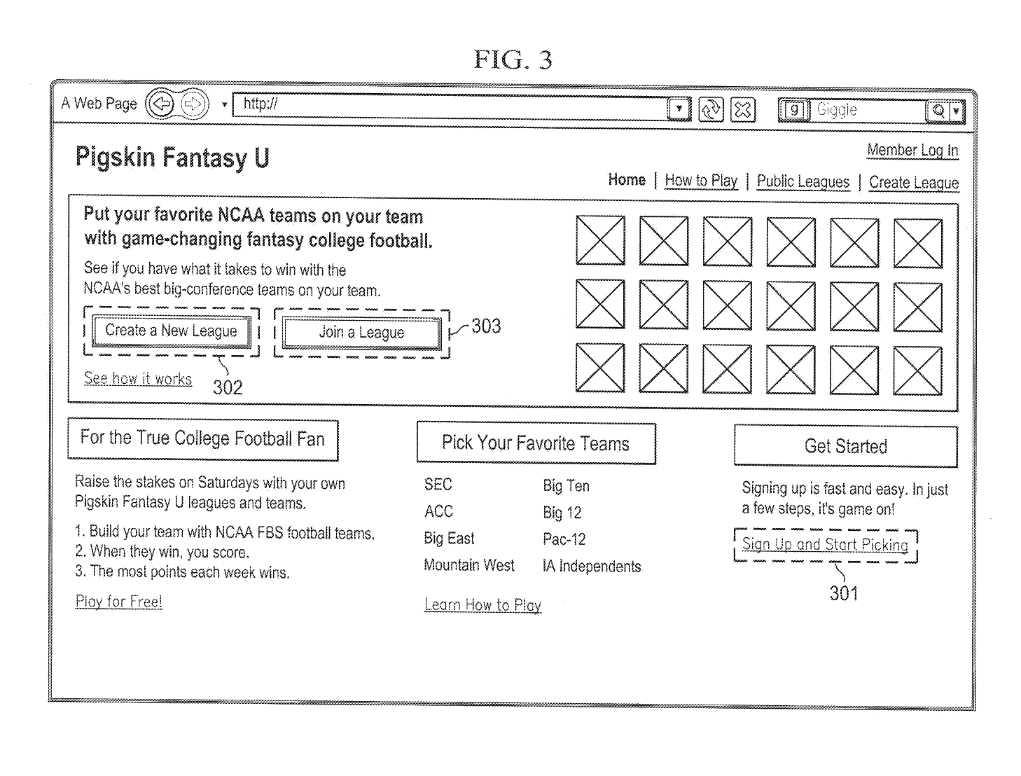

In other example embodiments, a user at a user station (e.g. user station 14 in FIG. 1) is presented with one or more graphical user interfaces (GUIs). Some example GUIs are shown in FIGS. 3-27. These figures also illustrate various aspects of at least some embodiments. For example, as illustrated in FIG. 3, a user may be presented with a home page GUI at user station 14. The home page may be a web page displayed via the Internet, for example. The home page has a number of links, buttons, etc. that may be clicked, for example, by guiding the cursor of a mouse over the appropriate area on the screen and/or clicking a mouse. The home page preferably has a game access link 301, which may be clicked to initiate user play activity. The home page may have other links, including a league creation link 302, and a league joining link 303. Link 303, for example, may access public or private leagues. Other links may provide for member logins, draft information, real team information, league information, game play information, social media activity, and so forth.

FIGS. 4-7 include GUIs that illustrate certain functionality associated with joining leagues and creating teams. In FIG. 4, for example, there are shown a number of existing leagues from which a user may select a league to joir. For each league, certain information is provide such as league name, league commissioner, the type of league (e.g., public or private), draft date, draft type (e.g., online or offline), and league capacity information. League capacity information is shown as two numbers, the first number being the number of user teams that are already part of the particular league and the second number being the total number of user teams comprising the particular league. Thus, if the capacity information is 4/6, then the league will consist of 6 total user teams and 4 user teams are already in existence in that particular league. These capacity restrictions may be set, for example, by the league commissioner. Similarly, the league commissioner may set other criteria such as draft type and draft date. A user may search for leagues using league search feature 401. The search may be confined using filters 402. New league creation link 403 is also provided to redirect a user to one or more web pages guiding the user through the process of creating a new league. If and when a new league is created, its league information may be included in the information illustrated, for example, in FIG. 4.

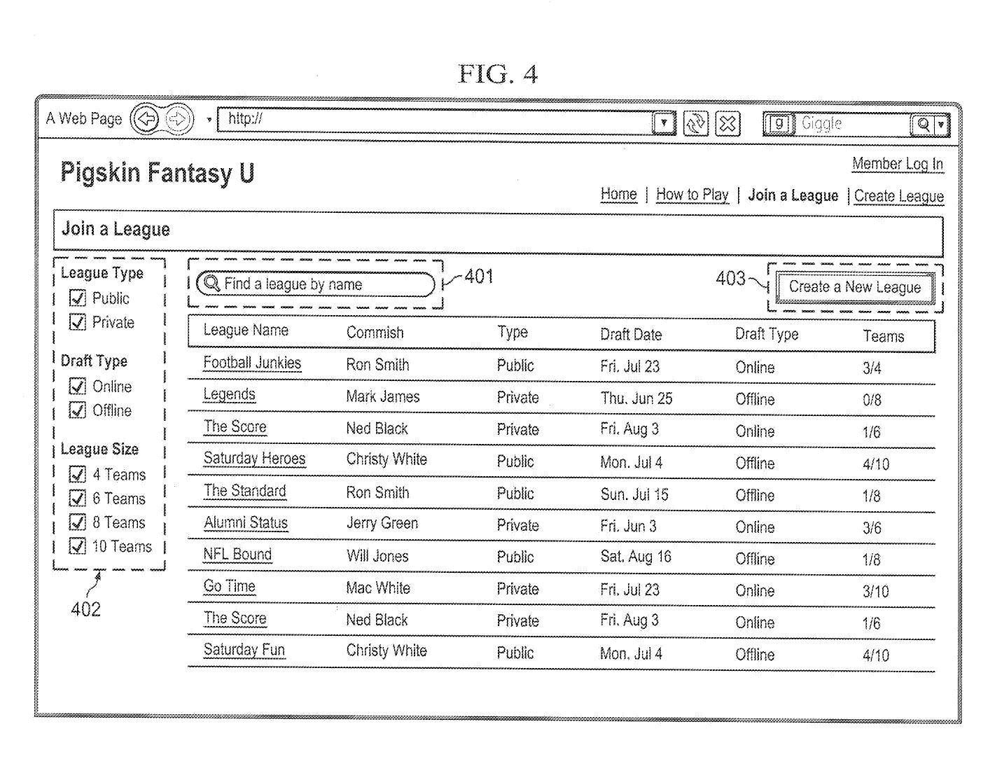

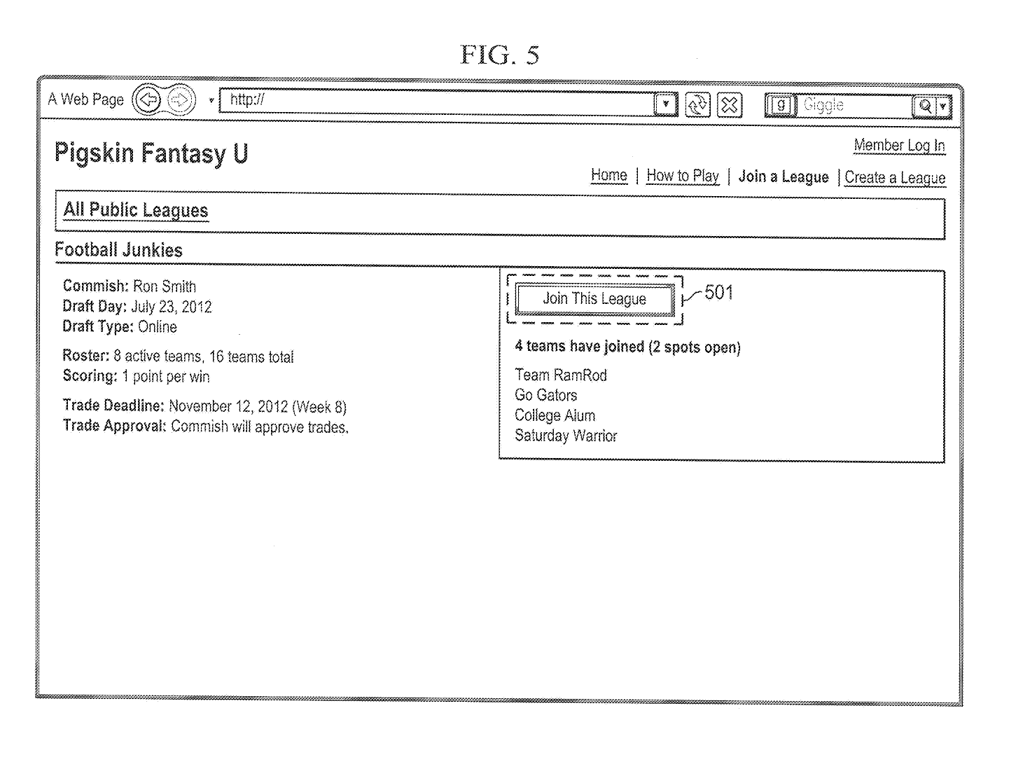

FIG. 5 illustrates another GUI containing more detailed information about a particular league, “Football Junkies.” This GUI may be accessed, for example, by selecting “Football Junkies” from the league list provided on the web page illustrated in FIG. 4. The information associated with the “Football Junkies” league includes the commissioner's name, draft type, and draft date. Also included is information concerning team structure. In this example, it is indicated that each user team will be comprised of sixteen total units, of which eight will be active. This means that a user will select sixteen total units (e.g., real sports teams) to be on his user team roster. Each play period (e.g., each week during the season), the user will select eight of his sixteen units to be active for that particular play period. Success of the user's team depends on the success of his active units from play period to play period. Thus, for example, in an embodiment directed to NCAA football, a user might select sixteen college football teams to make up his user team. From those sixteen college football teams, he might then choose eight teams to be active for each particular week during the season. This can be done up front or on a week-to-week basis. After the each week during the season, depending on how the user's active teams did, the user is awarded points. The user can then exchange one or more of his active teams for inactive teams on his roster in order to set the eight active teams for the following week of the season. As used in the discussion of this example embodiment, “units” refers to the units of the user team. In this particular example, a “unit” is a real college football team. In other example embodiments, a “unit” can refer to a group of individual athletes or members of a real team, a group of individual athletes or members from more than one real team, an individual athlete or real team member, or any other suitable unit to make up a user team. A “real team” can be an athletic team or any other type of group or team that competes with other “real teams” in any type of activity.

Other information shown in FIG. 5 includes information for scoring during game play (e.g., how points are awarded), trade deadlines, and trade approval criteria (e.g., whether the commissioner has to approve trades). Other information includes league capacity information such as how many user teams have joined, how may open spots remain in the league, and the identities of the presently-existing user teams in the league. Also provided is a team joining link 501, which enables a user to join the particular league being presented.

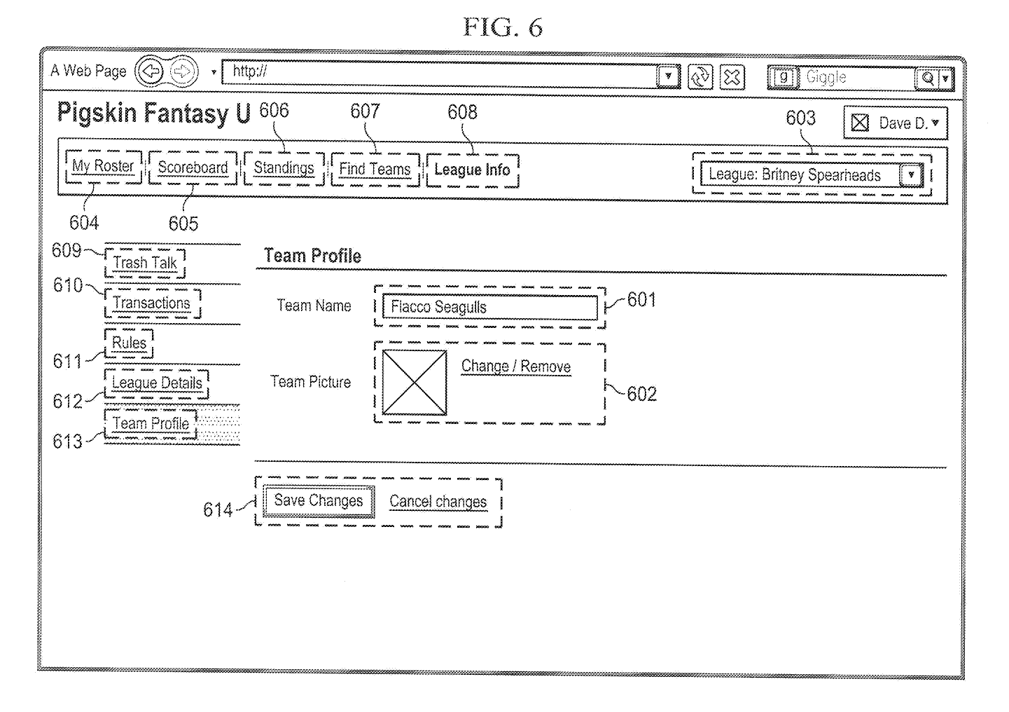

FIG. 6 illustrates a team profile page that can be used to set up a user team and/or to display information about a particular user team. The page includes a team name creation field 601, in which the user can enter the name of the new user team. The page also includes a team picture field 602 in which the user can insert a user team picture, logo, etc. The team picture field can link to, browse, or otherwise receive input from a user's computer files (e.g., such as saved JPEG files on the user's computer). The page further includes a league information link 603 to return to, or link to, a page showing information about the particular league at issue. A roster link 604 enables the user to move to, or link to, one or more pages concerning the makeup of the user's team roster. A scoreboard link 605 enables the user to move to, or link to, one or more pages concerning information about user team performance. A standings link 606 enables a user to move to, or link to, one or more pages concerning the rankings of a particular user team as compared to other user teams. A find-team link 607 enables the user to move to, or link to, one or more pages concerning information about a particular user team. A league-info link 608 enables the user to move to, or link to, one or more pages concerning information about a particular league and/or all leagues hosted by the game platform and/or website. A trash-talk link 609 enables the user to move to, or link to, one or more pages for enabling the user to provide commentary to one or more other users. A transactions link 610 enables the user to move to, or link to, one or more pages concerning information about transactions entered into, or performed by, the user. A rules link 611 enables the user to move to, or link to, one or more pages concerning information about the rules of play, terms of use, website instructions, and the like. A league details link 612 enables the user to move to, or link to, one or more pages concerning information about the user's league. A team profile link 613 enables the user to move to, or link to, one or more pages concerning information about the user's team. A change confirmation link 614 enables the user to confirm or cancel changes made to the information associated with the user team being created.

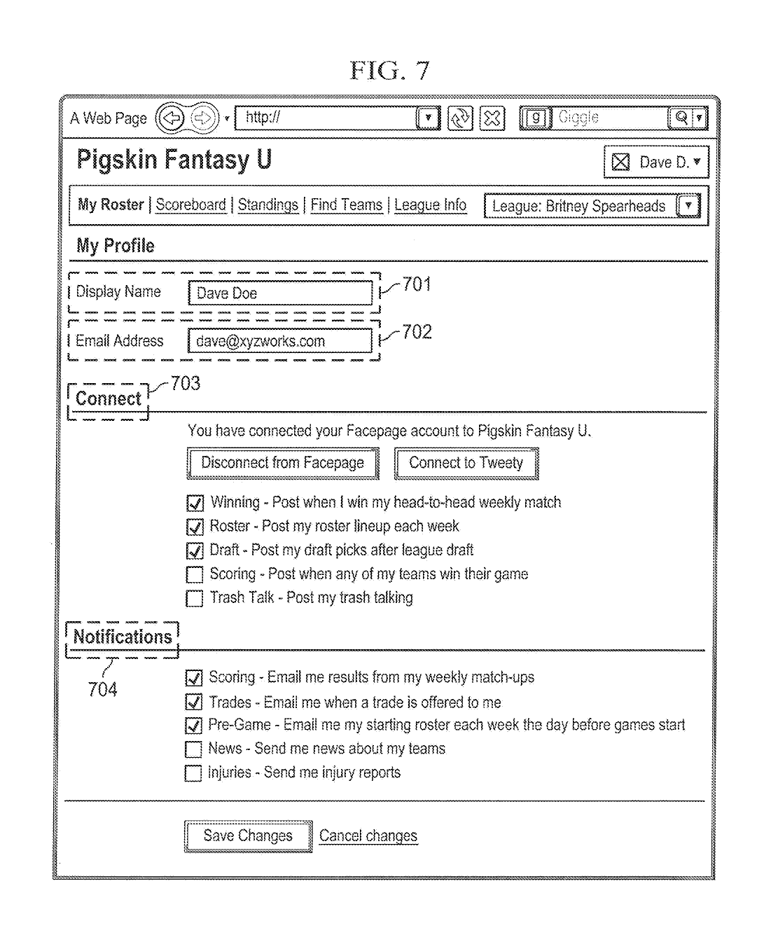

FIG. 7 illustrates a user profile page, which may be linked to one or more other pages, GUIs, sites, etc. supported by the game platform. The user profile page supports user identification, settings, and preference information. The page has a user name field 701, a user email address field 702, a connection preferences area 703, and a notification preferences area 704. Connection preferences area 703 allows connection to, and disconnection from, various communication networks, including social media networks, for example. Connection and disconnection may be based on user preferences including, for example, user wins, user team roster changes (or periodic postings of a user's roster, even if unchanged), draft information (e.g., draft picks made by the user), scoring information (e.g., when a unit on a user team wins a game), and trash talk postings. Notification preferences area 704 allows setting of user preferences including, for example, notifications based on scoring or win information, trade information, pre-game information, news, and injuries. Other information and links on the user profile page may include the roster, scoreboard, standings, find teams, and league information links previously discussed. Other information may include commissioner links, league information links, and save or cancel changes. It should be noted that this other information may be included on any of the GUIs as desired and/or applicable.

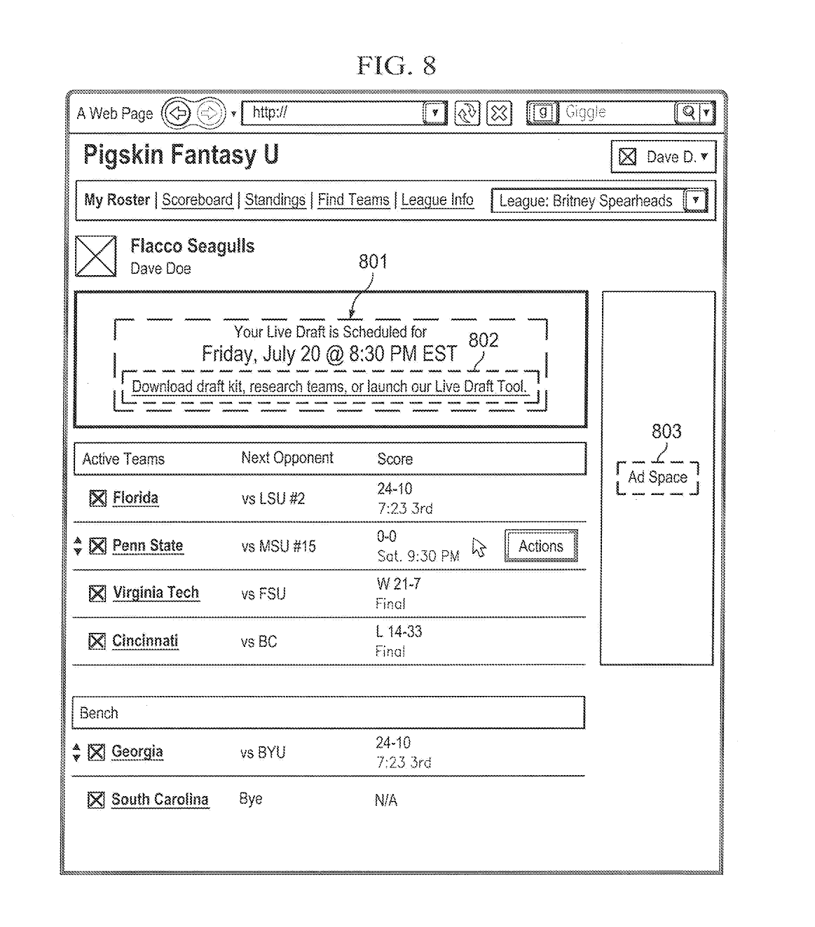

FIG. 8 illustrates a draft notification page. The draft notification page includes a draft notification section 801. Draft notification section 801 may include such information as date and time information for a scheduled draft. Draft notification section 801 may also include a draft information link 802, which links the user to information such as the draft process, draft research information, and applications for participating in drafts. Also included on the draft notification page is an ad space area 803. Ad space area 803 may support advertising of any suitable nature. It should be noted that any of the other GUIs described herein may include an ad space area as desired and/or appropriate.

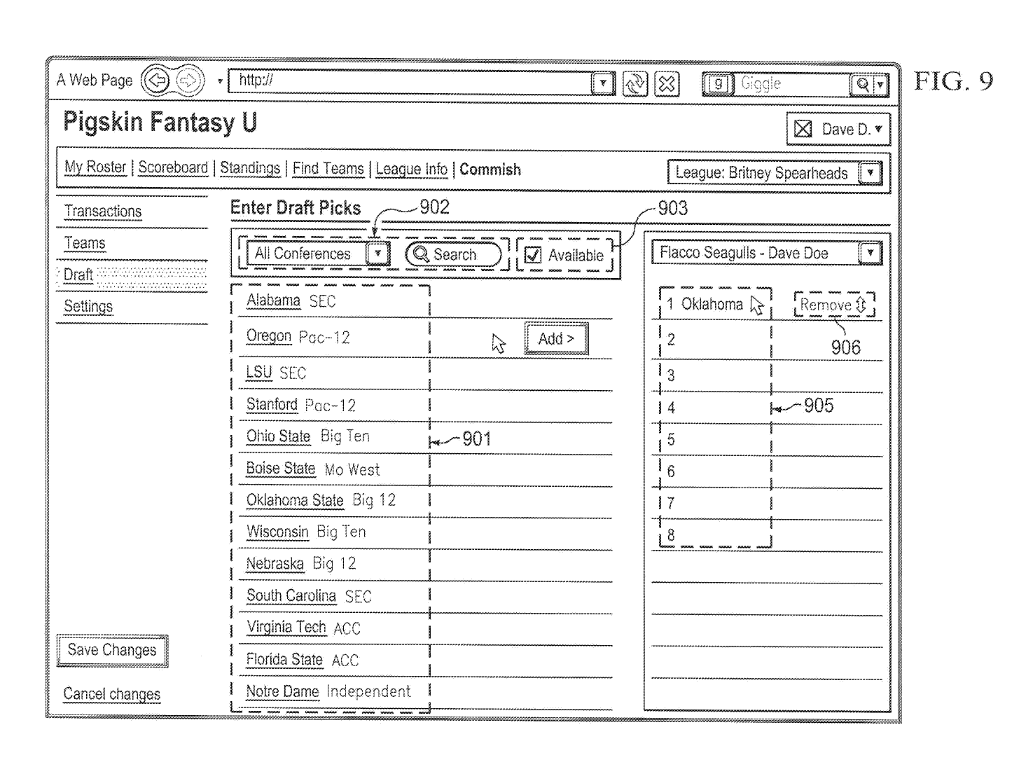

FIG. 9 illustrates a draft pick web page, which enables a user to make draft choices and/or draft preferences. The page includes a real team (unit) listing 901. Real teams, or units, are listed here. The units listed may be displayed according to whether or not they meet certain search criteria and/or filter restrictions. The page also includes a unit search area 902. Unit search area 902 may include a drop-down menu or other device for selecting search criteria. Area 902 may also include a search field for accepting, for example, key words. A display filter 903 may also be provided. The illustrated example display filter is simply a filter to indicate whether the displayed units are still available to be drafted. The units (or real teams) displayed in listing 901 may be configured as links. A user may access the link to gain information regarding the particular real team selected. The information can include any suitable information about the team including, for example, win-loss records, schedules, player information, injury reports, and information about other users, leagues, user teams and the like associated with the real team by, for instance, a prior draft of the real team by that particular other user. An add button 904 enables the user to add particular units to his draft preferences. A remove button 906 enables a user to remove units from his draft preferences. A draft preference listing 905 displays a user's draft picks. The picks can be units actually selected during a draft process or an indication of the units and/or order of units which the user wants to draft. The draft pick page may also include other information, areas, and links as described elsewhere herein.

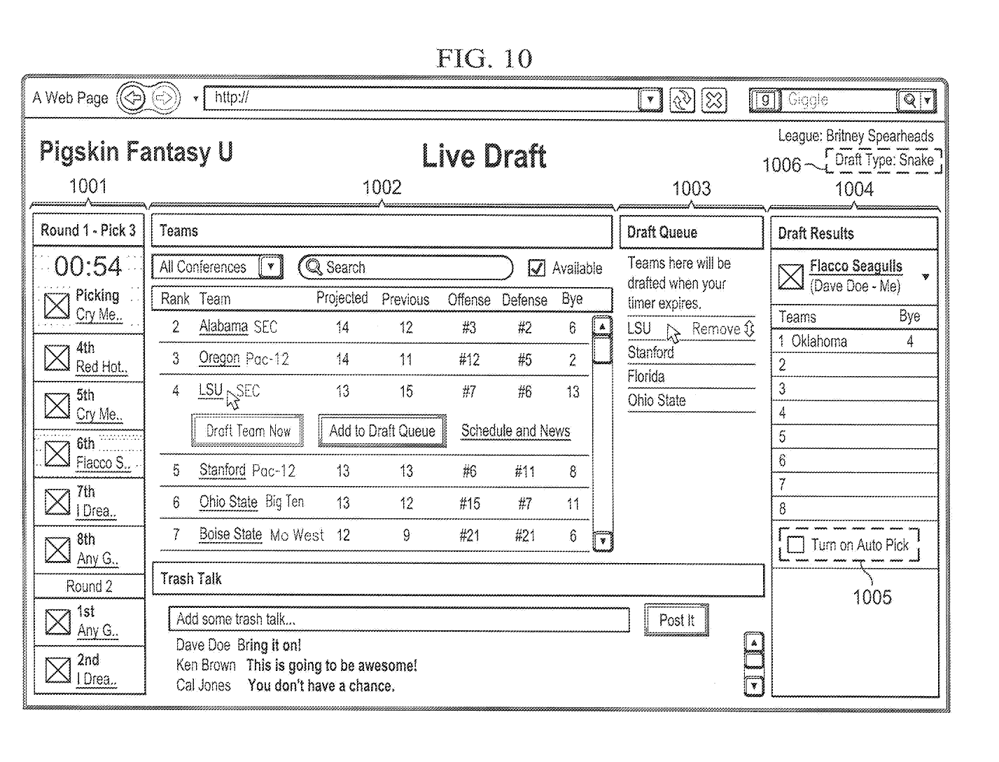

FIG. 10 illustrates a live draft web page, which enables users to participate in a draft from available real teams (units) to fill their respective user teams. Round and pick area 1001 displays information showing the current round of the draft and the current pick within that round. It can be seen (near the bottom of the page), that two user teams have already made their first round picks. Thus, the upper user team under the round 1 indicator is making the third pick in round 1. There is also a digital time indicator to show how much time is left for the pick, the round, or for any other suitable activity governed by time limits. Unit display 1002 displays information about the real teams (units) that are available for the draft. Certain information displayed may include, for example, real team name, rank, projected number of wins, number of wins in prior season, offensive rank, defensive rank, and the bye week for the particular real team. A user may scroll down the list of real teams and, if it is their turn in the draft, may daft a selected team. Optionally, a user may select one or more teams to add to that user's draft preferences queue. Searching, search criteria, filters, schedules, team information, and news are also provided (in some or all cases by way of links). Draft queue 1003 is a display of a particular user's draft preferences queue. A user may add or delete teams from his queue. The queue is a device to assist a user in organizing their draft strategy. An auto-select button 1005 is provide to enable a user to let the game platform automatically make draft picks for the user based on, for example, the user's draft queue preferences. A draft results indicator 1004 displays draft results for a particular team. Other functionality such as, for example, trash talking, posting comments, and linking to other web pages or GUIs is provided.

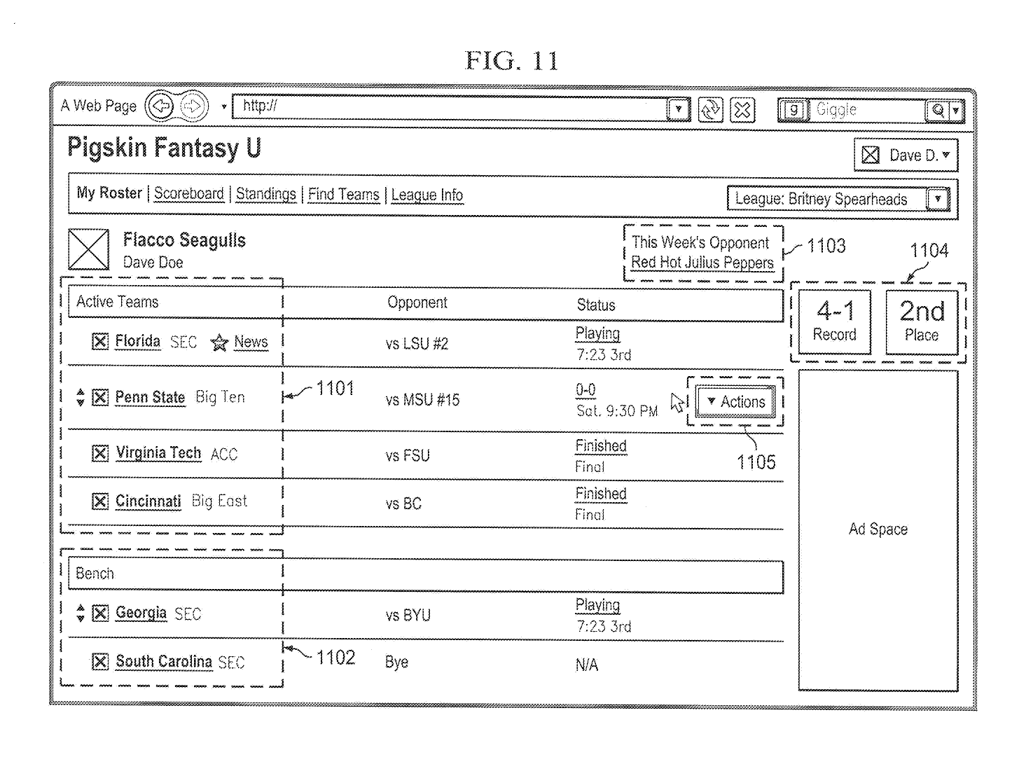

FIG. 11 illustrates a roster status web page, which enables a user to visualize his active and benched units, and conduct other activities. Active unit display 1101 displays the real teams (units) of the user team that are active for the play period. “Active” means the unit is in play for the particular play period (e.g., the particular week during the college football season). Benched-unit display 1102 displays the real teams (units) that are benched for the particular play period. “Benched” means that the unit is on the roster of the user team but is not in play (i.e., its performance has no impact on the user team's performance) for the particular play period. Also displayed is status information for each particular real team opponent of the real teams on the user team. This status information can include an indication of whether the teams have played, are playing, or have yet to play. This status information can also include, for example opponent real team ranks, bye week indications, win-loss records, and other information. A current opponent indicator 1103 displays the current user team opponent for the play period. In this example, Flacco Seagulls is playing Red Hot Julius Peppers. A link to the opposing user team's information may also be provided. It should be noted that this example is displaying head-to-head user competition in that Flacco Seagulls is only playing one other user team for the given week. The display would be adjusted accordingly for one-against-all user competition. A record-and-rank indicator 1104 displays the record and rank of the user team and/or the opposing user team. An actions tab 1105 may also be provided to allow the user to undertake other activities such as dropping, adding, and trading teams, for example.

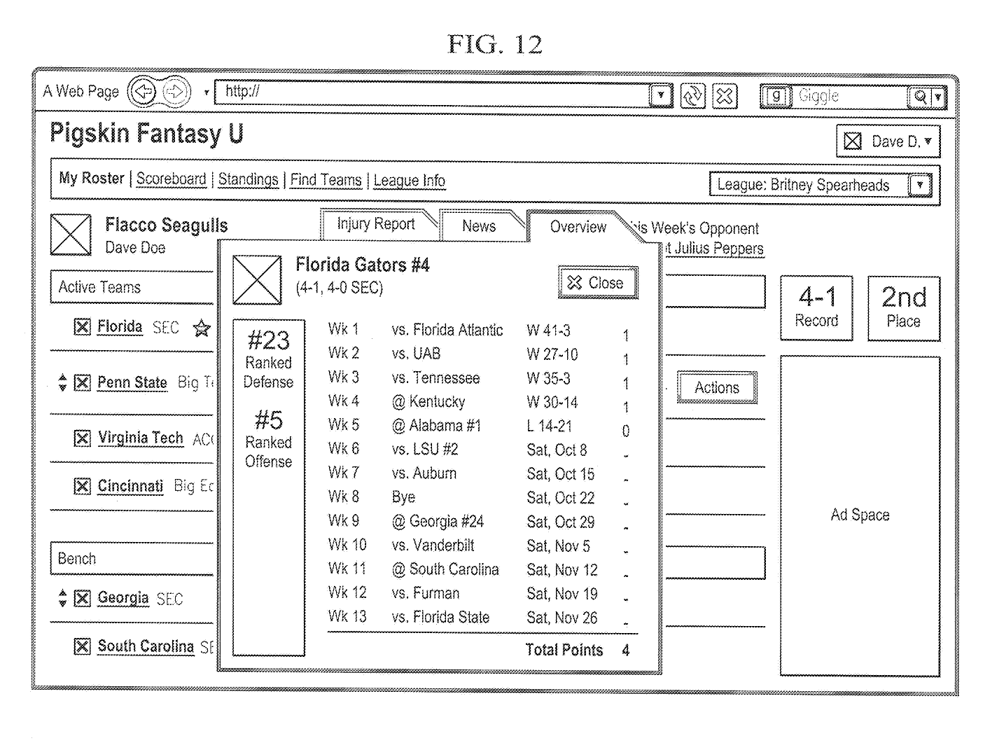

FIG. 12 illustrates a unit status window. This window may be accessed, for example, by clicking on the particular unit displayed in either the active or benched listings provided on the page shown in FIG. 11. Of course, the system may be configured to access this information via other links on other pages. The unit status window provides information regarding the real team (unit) selected. The information can include, for example, schedule, win-loss information, scores, game dates, play period information (e.g., which week of the season), ranking information (e.g., overall, offensive, defensive, etc.), user team performance and point information, real team injury and news information, and the like. Certain information may be accessed by clicking links, or clicking on tabs to open additional windows.

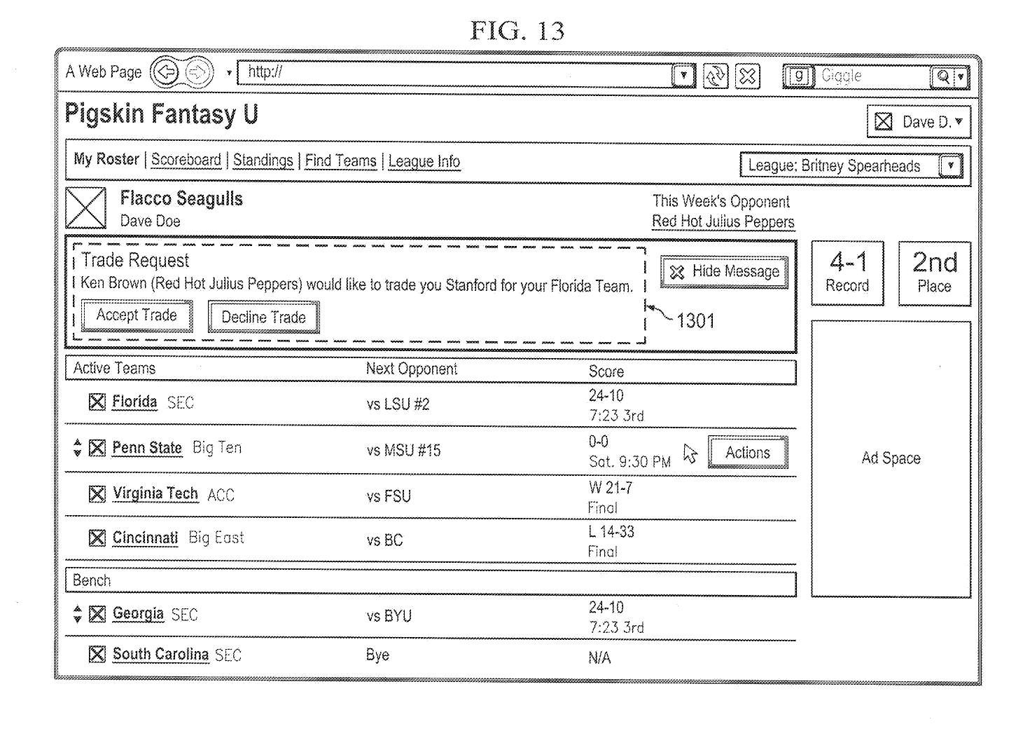

FIG. 13 illustrates a roster status page with a trade request notification. A user might get to this page by selecting the roster tab, by logging on and seeing a trade request pending, or by linking via a trade request email, tweet, or other social media message. Trade request notification 1301 may include any suitable information about the pending trade such as status (e.g., complete, pending, under review, awaiting commissioner approval, etc.). Other information may include, for example, the name of the requesting user team (and owner), the unit (real team) being offered), and the unit (real team) that the requestor would take if the trade is executed. Accept and Decline buttons are also provided for the user to accept or decline the trade. Accepting a trade may, in some embodiments, kick the accepted trade request to the commissioner (or other approval entity) for review, approval, and/or execution.

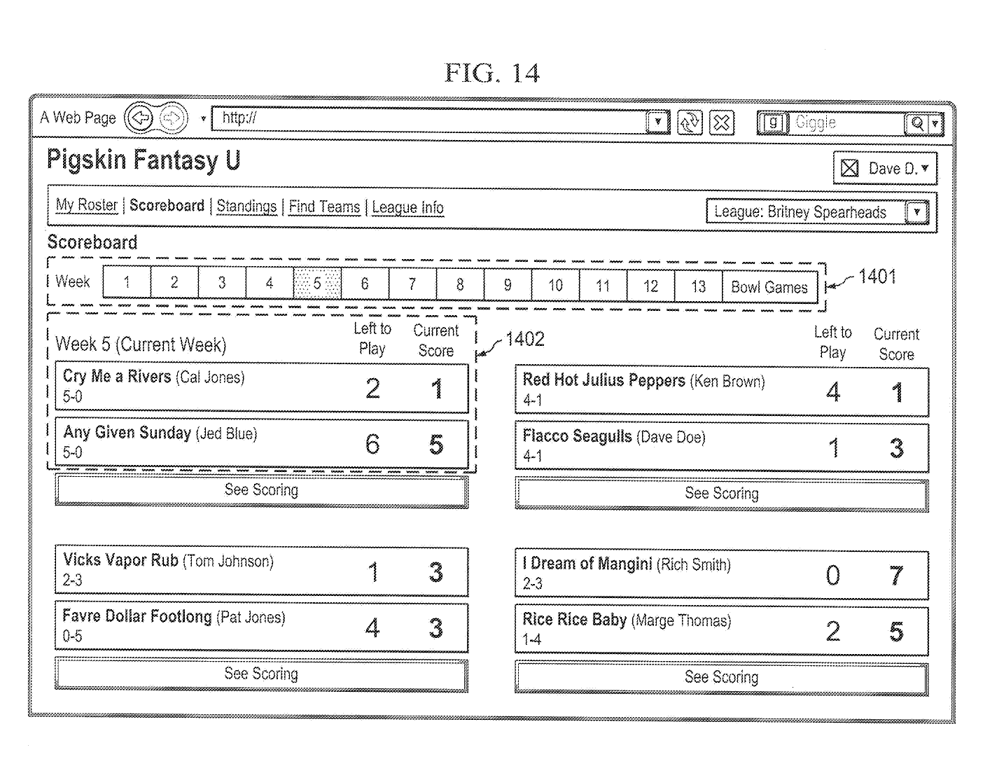

FIG. 14 illustrates a scoreboard webpage, which may be accessed, for example by a user clicking on a scoreboard tab or link. The page provides information concerning the performance of user teams during the current play period (e.g., the current week of the season). Play period indicator 1401 provides an indication of the particular play period in this example, the current week of the season). The indicator may provide for selecting non-current play periods to view past and future match-ups and corresponding information. One or more match-up displays 1402 may also be provided. A match-up display may provide, for example, the names of the opposing teams, their ranks, current scores, number of ranking places behind the leading user team, number of real games that the user team's units have left to play in the respective play period, and the number of additional unit (real team) wins necessary to clinch a user team win for the particular week. A scoring tab 1403 may be accessed to view more detailed scoring information for the various user teams for the particular play period being viewed.

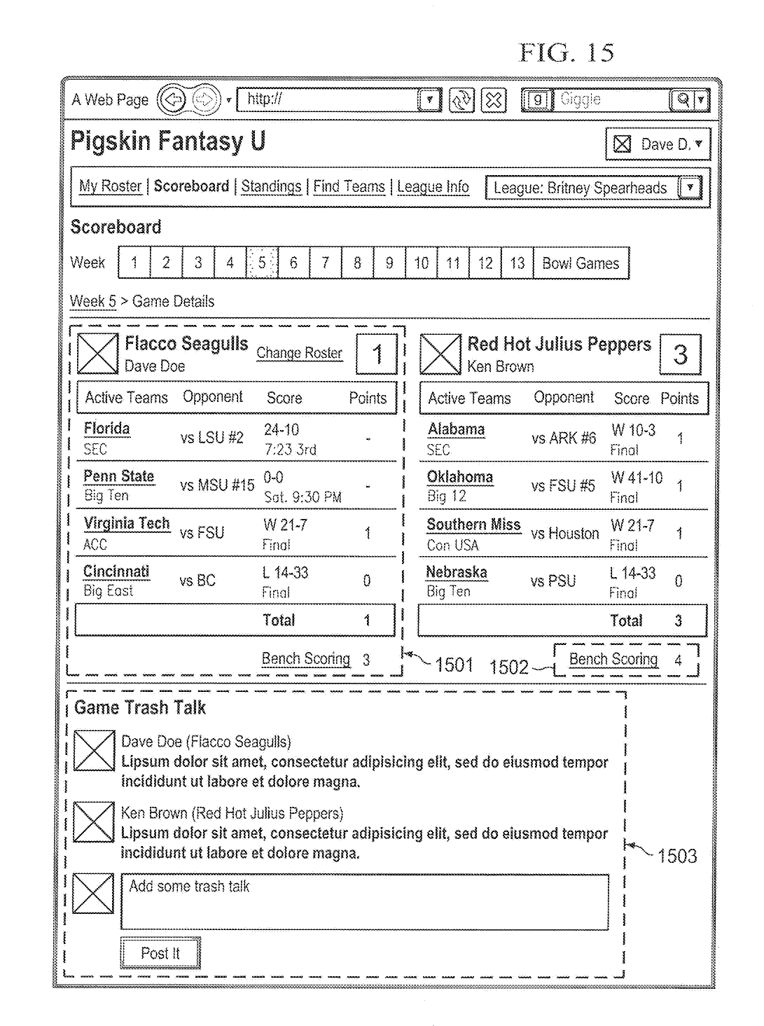

FIG. 15 illustrates a scoring detail web page which may be accessed, for example, via a link provided on the scoreboard web page illustrated in FIG. 14. This scoring detail page provides more detailed information regarding performance of periods. For example, for the particular play period, information for some or all of the games being played by the real sports teams will be displayed. Game information display area 1501 shows all of the games for the active teams (units) of the user team Flacco Seagulls for the fifth week of the season. Information displayed includes, for example, unit name, unit opponent and rank, win/loss information, scores, and points awarded to the user. Similar information is displayed for the user team's opponent or opponents. In this case, which is an example of head-to-head play, Flacco Seagulls' opponent is Red Hot Julius Peppers and similar information is likewise displayed for the units of that user team. Also displayed is a bench score indicator 1502. This indicates the points that would have been awarded had the benched units been selected as active by the user. Trash talk display area 1503 allows the user to engage in messaging regarding team performance, opponent user teams, and the like.

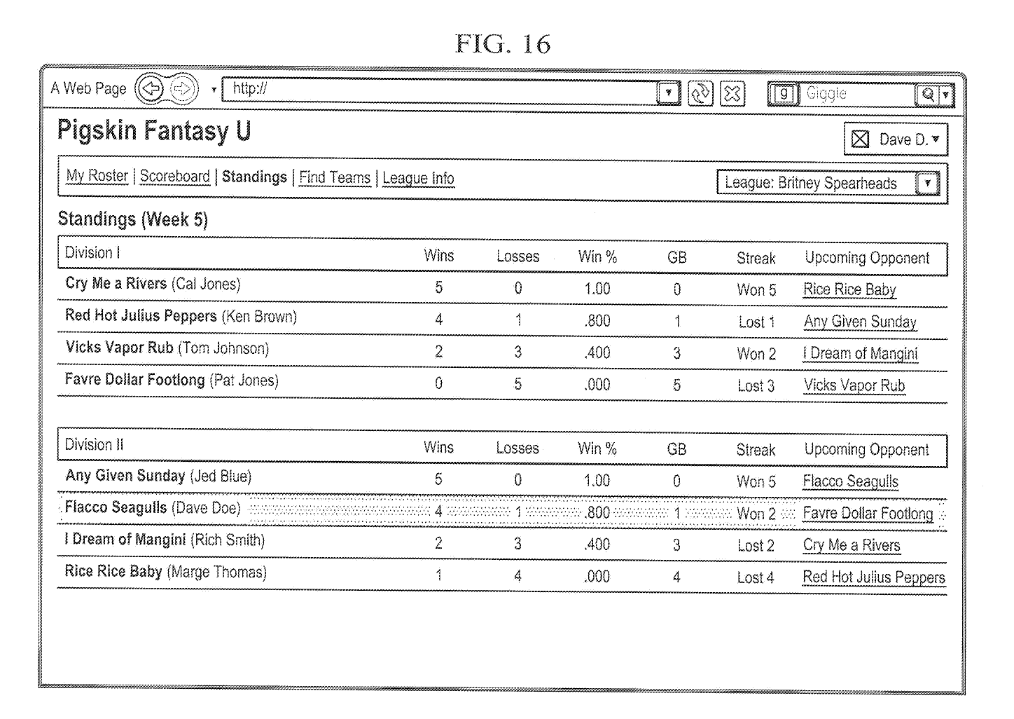

FIG. 16 illustrates a standings web page, which may be used to display the standings and other related information of the user teams within a league. The standings may be the current standings. Alternatively, and not expressly shown, the page may be configured to allow a user to display standings as of a prior play period. Displayed information may include, for example, user team names, win/loss information, winning percentages, games behind the leader, win/loss streak information, and upcoming opponents.

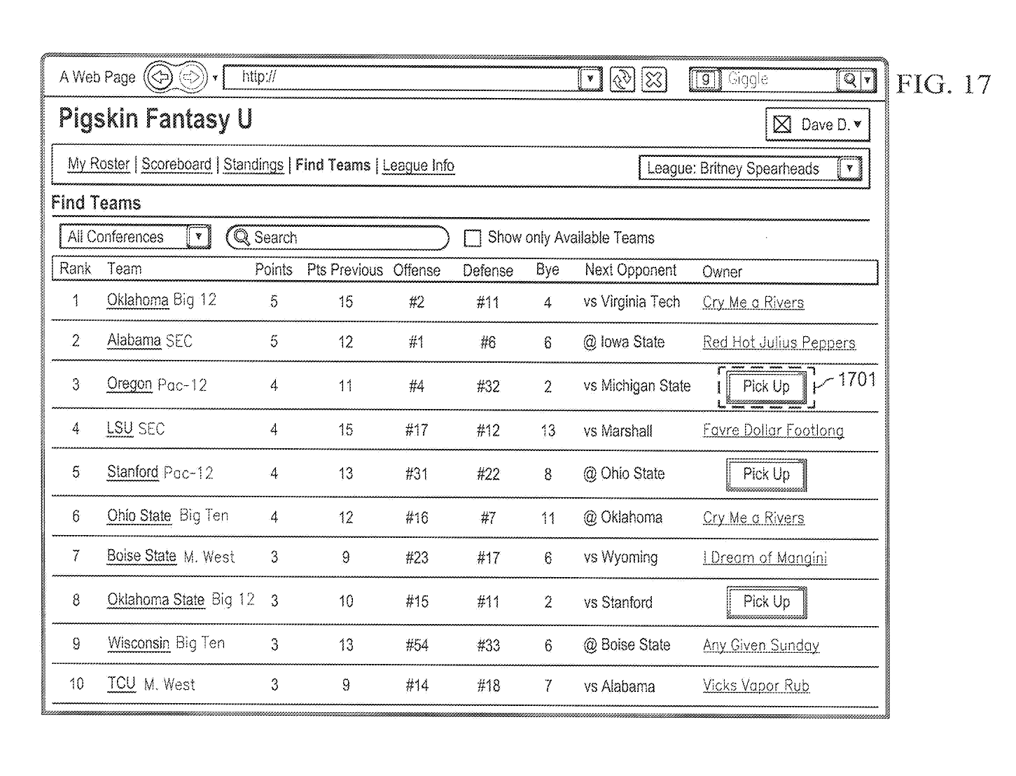

FIG. 17 illustrates a unit information webpage, which provides users with information about the real teams in the sport or activity supported by the system. In this example, the page provides information about at least some of the college football teams. The page can provide information about all units, or only some of the units. If only some of the units are provided, which units are displayed may be determined by any number of criteria. For example, the figure shows the display of ten college football teams based on their overall ranking. Other information provide may include points that the unit won for its owner so far in the season, points won for the owner during the prior season, offensive and defensive (and other) ranking information, bye week identification, next opponent information, and owner identification. A pick-up button 1701 enables a user to select a team that still has not been drafted by a user, or is otherwise available, such as when a unit (real team) has been offered for trade.

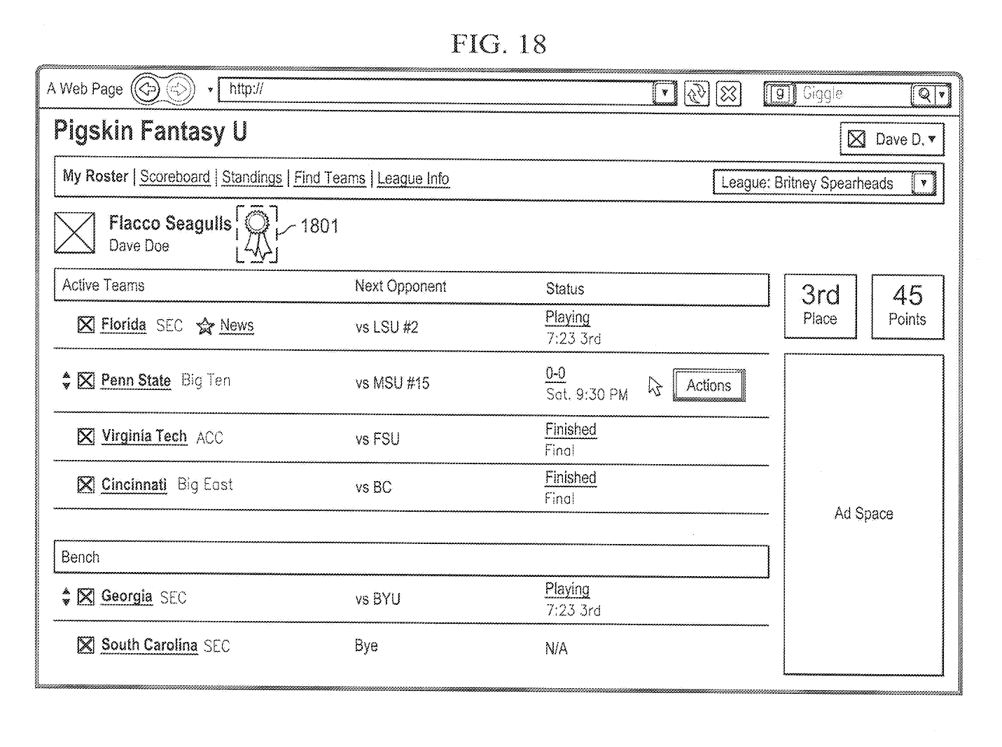

FIG. 18 illustrates an awards page, which provides users with information regarding awards given to a particular user team. The page is similar to that shown in FIGS. 11 and 13. However, this page also displays user team rank and points information. Also provide is an awards indicator 1801. The indicator itself may be the award. Alternatively, the indicator may indicate an award given to the user that owns the particular user team. For example, an image of a trophy might indicate that the user was actually provided with a real trophy.

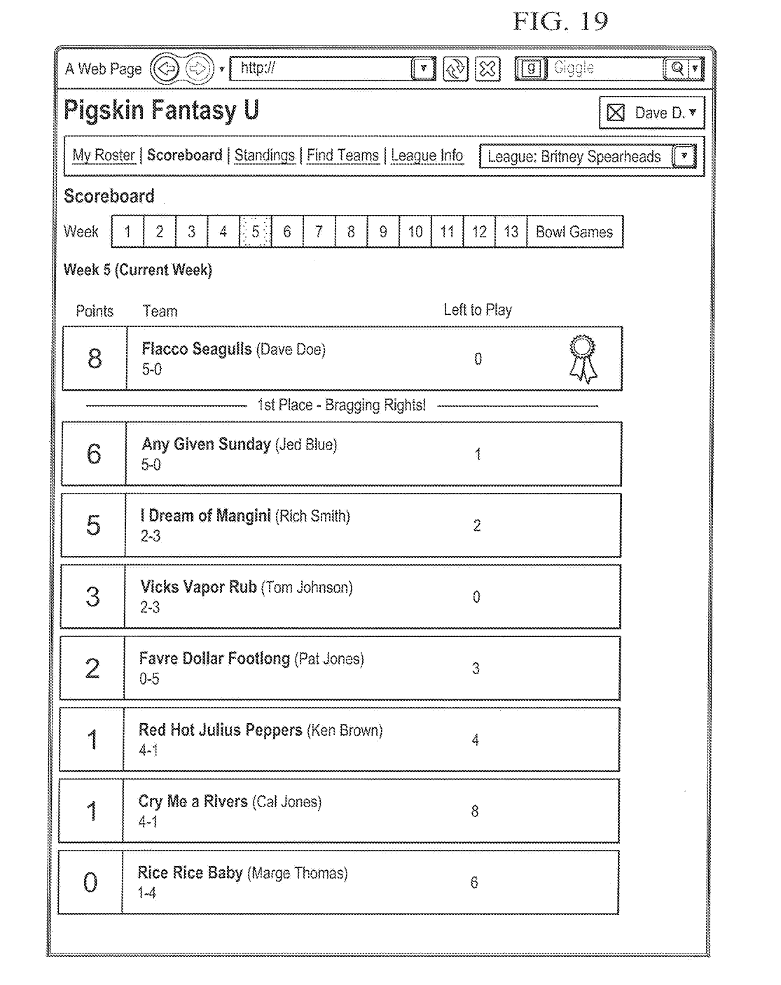

FIG. 19 illustrates a display associated with a one-versus-all game format. The play period represented, for example, is week five of the season. The left column indicates how many games have been won by the user team's unit during the play period. The right column indicates how many games are left to be played by the user team's units during the play period. For example, the example screen shot indicates that during the week-five play period, all eight of Flacco Seagulls' active units (real college football teams) have played, and all eight won their games. Thus, Flacco Seagulls can do no worse than tie for first during week five. Therefore, they have been given an award indicator. Favre Dollar Footlong's active units have won two games and have three left to play. That means that five of that user's units played so far during the week-five play period and, of those five, three lost their games.

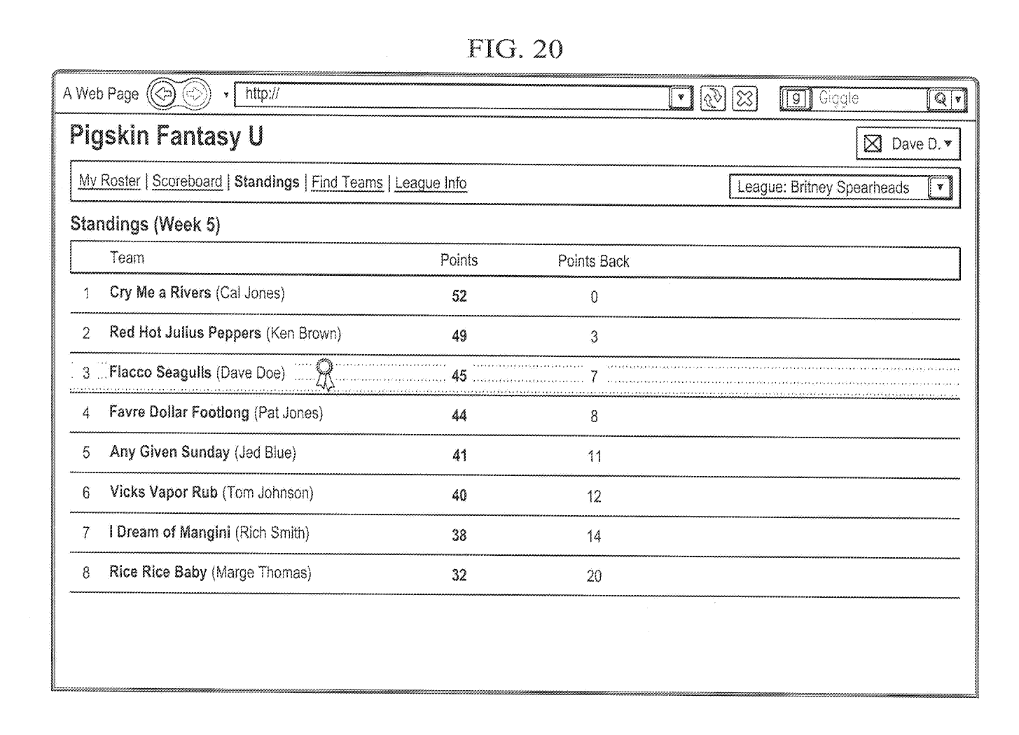

FIG. 20 illustrates a standings webpage in a one-versus-all context. The user teams are identified and ranked. In this example, the user team rankings are according to overall points earned so far during the season. Also displayed is the number of points that each respective user team is behind the leading user team.

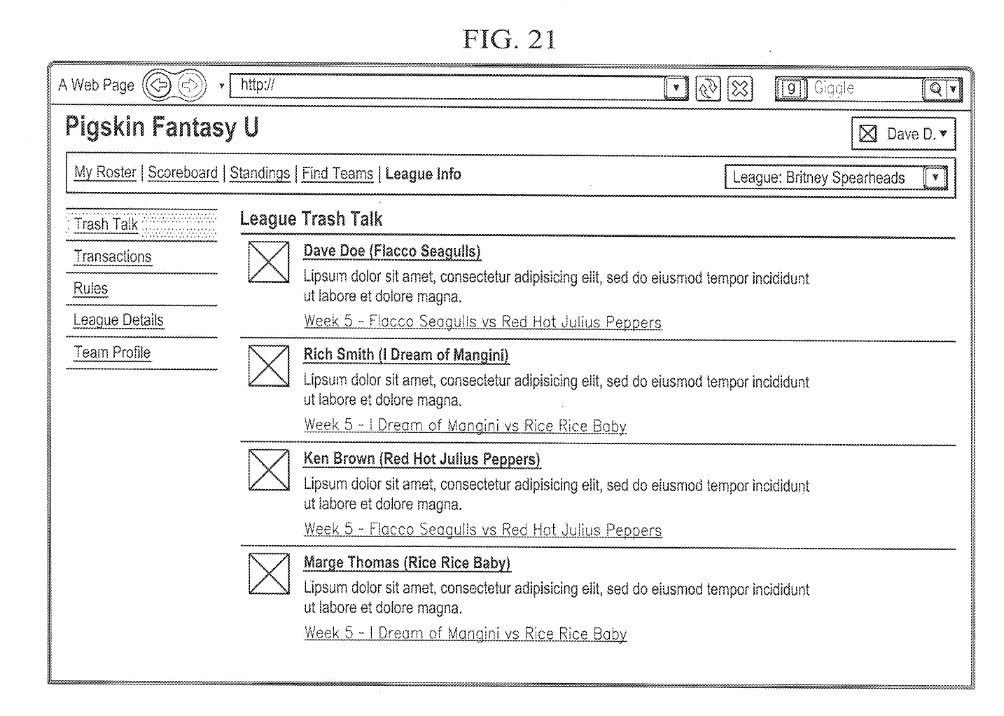

FIG. 21 illustrates a trash talk webpage. This page enables a user to post comments. Comments may be posted via the website itself or via other external media networks. Users may select individual users or groups of users to whom comments are posted or sent.

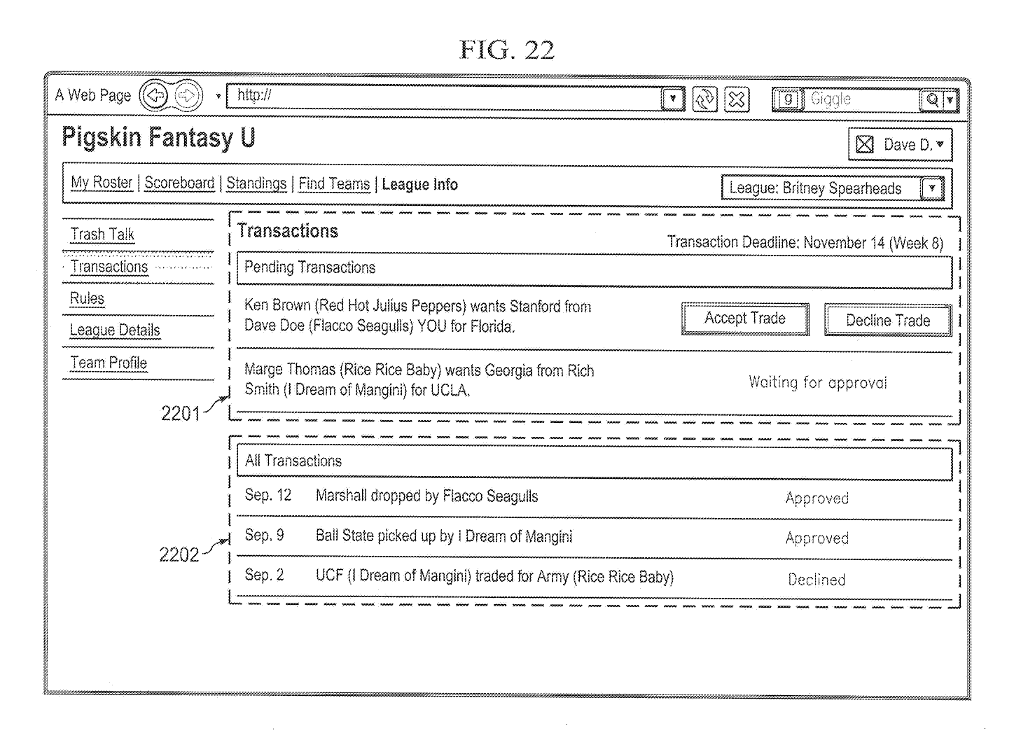

FIG. 22 illustrates a transactions webpage, which enables users to conduct transactions and view information concerning transactions. Transactions may include, for example, proposing trades, accepting trades, declining trades, moving units between active and inactive (benched) status, selling units, selling teams, picking up available units, dropping units from the user team, advertising, and any other action which may be taken by a user in connection with his participation in the game. In the example webpage illustrated, there is a pending transactions area 2201 and a completed transactions area 2202. Pending transactions area 2201 displays all transactions that have not yet been completed. For example, this area might display a proposed trade that has not yet been approved (e.g., by the commissioner), or an approved trade that has not yet been accepted or declined by the owner of the respective user team to which the trade was proposed. Other pending transactions may be displayed here such as when a user proposes to pick up an available unit or drop a unit from his user team. Pending trades that are waiting for certain user action may have a button, link, etc. to enable the user to undertake the require action. For example, an approved trade may have associated accept and decline buttons that the appropriate user may use to accept or decline the trade. Completed transactions area 2202 displays information regarding transactions that have already occurred. The transactions displayed may be dictated, and/or grouped, by any number of suitable and desired criteria, such as date of transaction, age of transaction completion, type of transaction, user team(s) involved in the transaction, and transaction result, for example. The example webpage illustrates a drop transaction on September 12^{th} that was approved (e.g., by the commissioner), a pick-up transaction on September 9^{th} that was approved, and a trade that was (presumably) approved, but was declined by the respective user team owner.

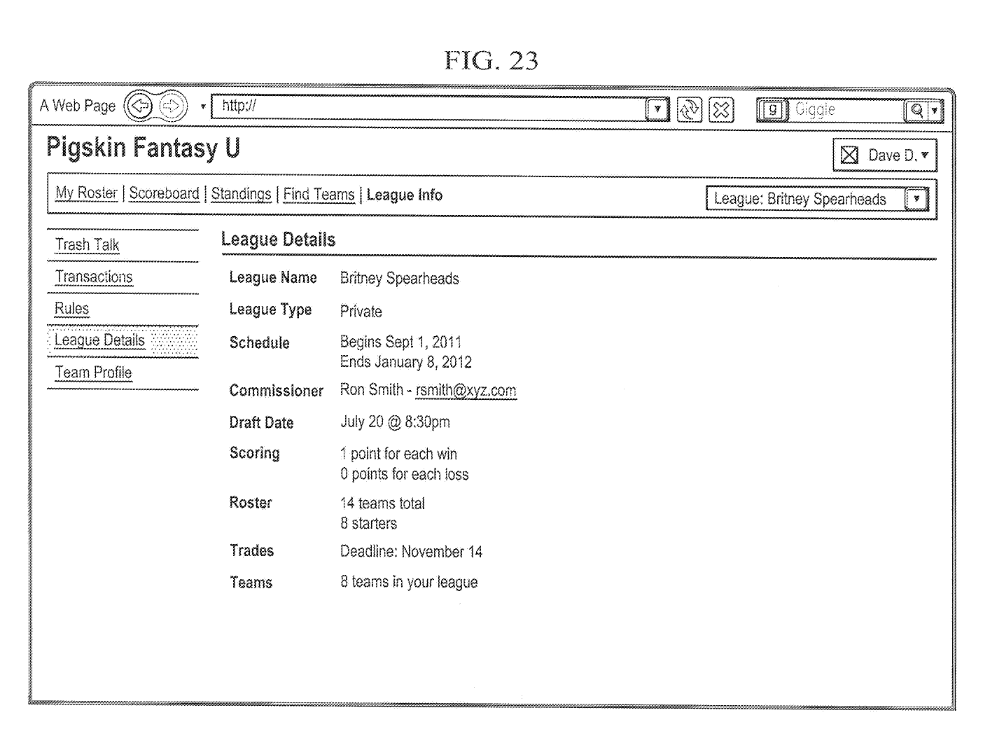

FIG. 23 illustrates a league details webpage, which provides users with certain information regarding a particular league. The information may include, for example, league name, league type (e.g., public or private), schedule information, season start/end dates, commissioner information, draft information (e.g., date, time, and type of draft), roster capacity information, trade information, and information regarding teams in the league.

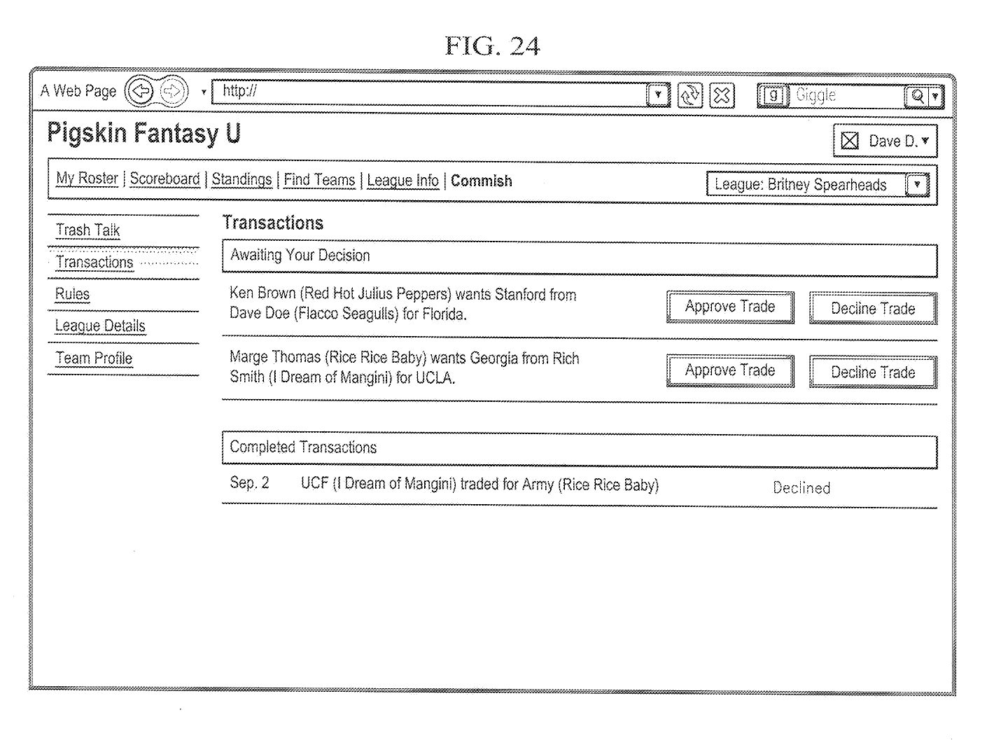

FIGS. 24-27 illustrate some examples of webpages for use by a league commissioner. FIG. 24, for instance, illustrates a transactions approval web page, which allows an authorized user (e.g., a league commissioner) to consider trade requests and approve or deny them. For example, two pending trade requests are shown. Also shown are approve and decline buttons that the commissioner can click to approve or deny the trades. Trades may be first approved or rejected by the commissioner and then accepted or declined by the user being offered the trade. Alternatively, the user may first accept or decline, followed by approval or denial by the commissioner. Still another alternative is that the user and commissioner actions are independent with respect to order, but the trade is not executed unless and until both the commissioner and the user have responded positively. On the page shown in FIG. 24, completed transactions may be displayed according to various criteria such as, for example, transaction date and/or age, transaction type, and transaction status.

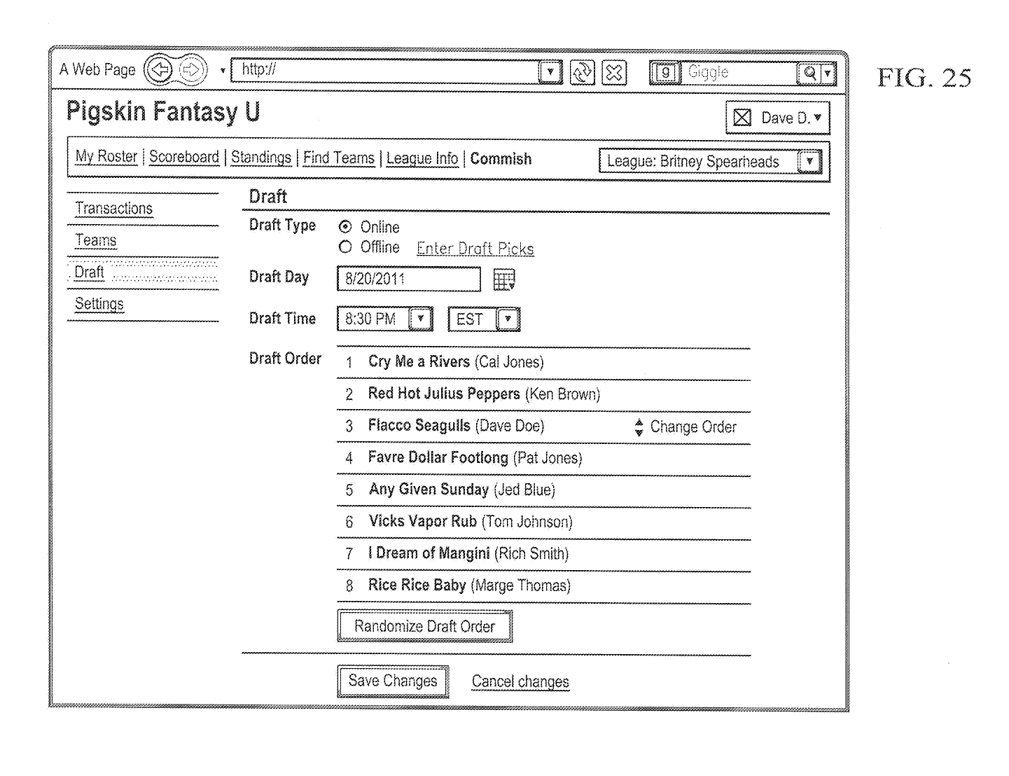

FIG. 25 illustrates a draft control webpage, which allows an authorized user (e.g., a commissioner) to set up and run a draft. The page allows the commissioner to set draft type (e.g., online/offline, etc.), draft date/time, and draft order. Notices to users (e.g., draft information, emails, reminders, calendar invites, etc.) may be initiated from this page.

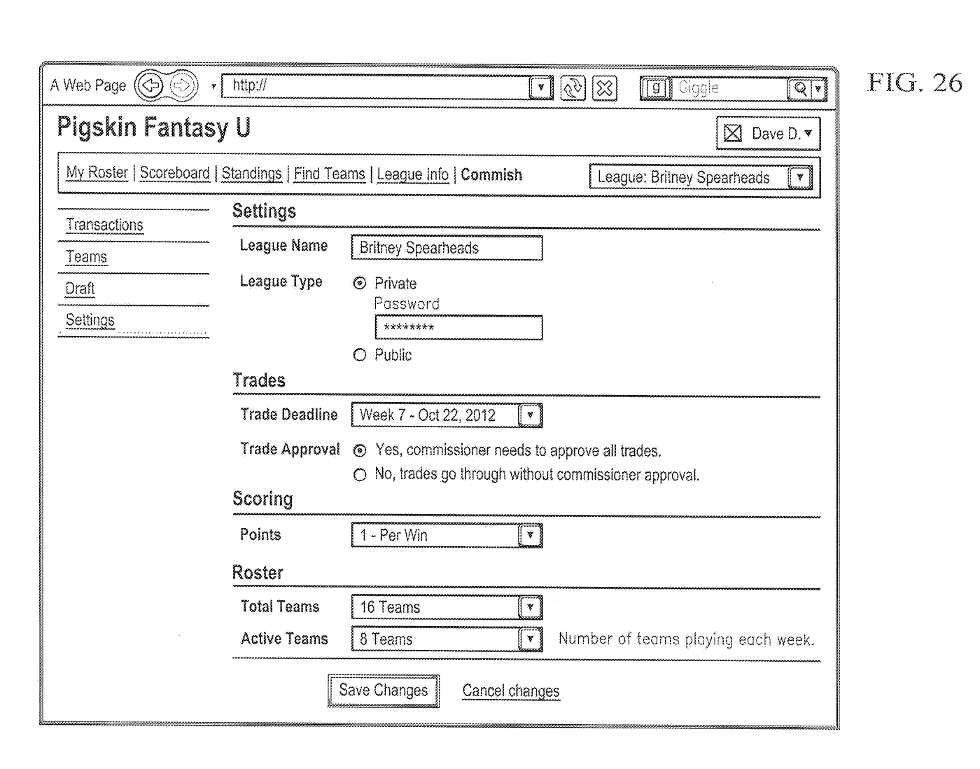

FIG. 26 illustrates a league settings control webpage, which enables an authorized user (e.g., a commissioner) to establish various parameters for particular leagues. For example, the commissioner may set a league name, league type (e.g., public/private), trade requirements (e.g., date/time, whether commissioner approval is required, etc.), scoring (e.g., number of points per win, whether points vary depending on type of game, season/postseason, bowl games, playoffs, etc.), and roster capacity and restrictions (e.g., number of units on a roster and number of active units versus benched units).

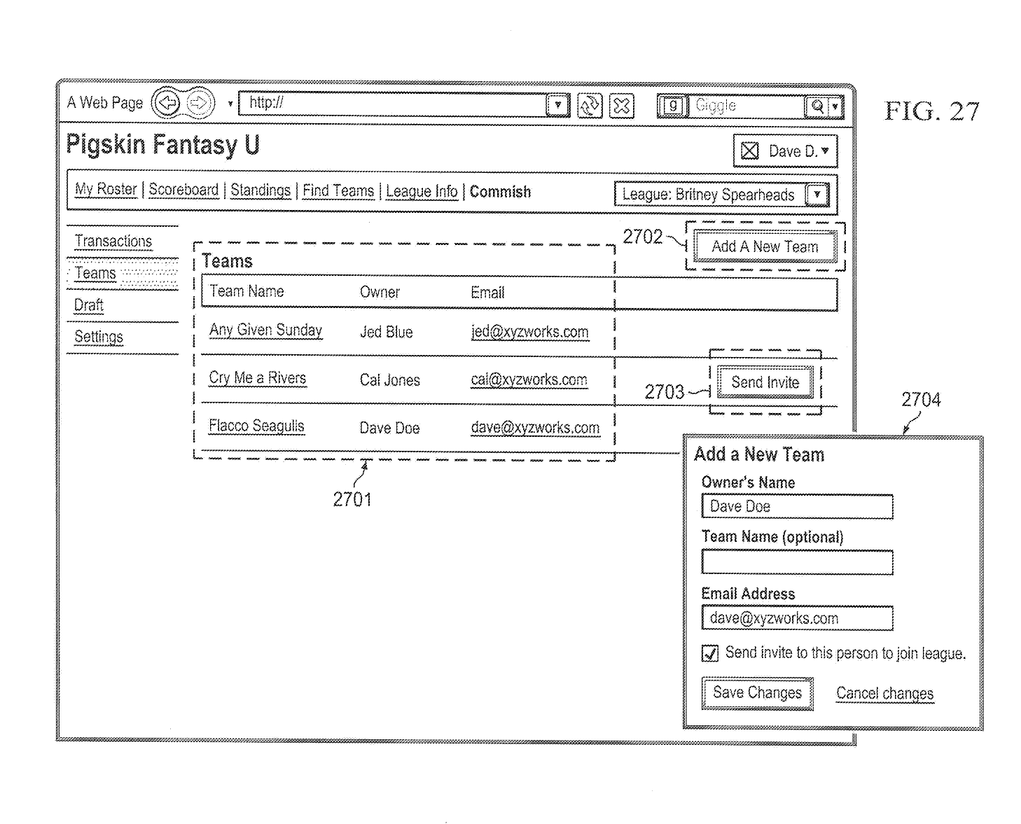

FIG. 27 illustrates a league fulfillment webpage, which may be used by an authorized user (e.g., commissioner) to control creation/deletion of user teams, editing of user team information, and invitations to join user teams. A team listing area 2701 provides a listing of user teams including team names, owner names, and owner email addresses (or other appropriate contact information). Team names may link to a team information page and/or a team information editing page. An “add new team” button enables the user to add a new team by clicking on the button. When this is done a team addition/deletion/editing pop-up window 2704 is displayed to enable the user to add or delete teams, or edit team information (e.g., team name, owner name, owner contact information, etc.). Invitation button 2703 enables the user to initiate invitations to prospective league members.

It should be understood that other aspects of the invention and other embodiments will be apparent to those having ordinary skill in the art. Certain other embodiments or variations to embodiments described herein are considered to be a part of the disclosure. Modifications may be made to the systems and components described herein. For example, although various software modules are described as residing on various system components, the software modules and functionality may reside on different components than as described and in different combinations than as described. Additionally various modules may be combined and various software functionality may be provided in different combinations than as described.

What is claimed is:

1. A game system, comprising:
a host platform adapted to be connected to one or more user stations and operable to send and receive electronic information, the host platform comprising one or more computers operable to execute one or more software modules, the host platform further comprising one or more databases electronically connected to the one or more computers,
wherein a first software module is operable to receive user team creation requests from a plurality of users, present the users with a plurality of real team units, and accept from the users selections of a plurality of the real team units as members of the user teams, and
wherein the host platform is operable to compare performance of at least two user teams.

2. The game system of claim 1, wherein the real team units comprise sports teams.

3. The game system of claim 1, wherein the real team units comprise college football teams.

4. The game system of claim 1, wherein the comparison of the at least two user teams comprises comparing the win records of the real team units of the respective user teams.

5. The game system of claim 1, wherein the comparison of the at least two user teams comprises comparing a performance of a first one of the user teams to a performance of a second one of the user teams.

6. The game system of claim 1, wherein the comparison of the at least two user teams comprises comparing a performance of a first one of the user teams during a predetermined period to a performance of a second one of the user teams during the predetermined period.

7. The game system of claim 1, wherein the comparison of the at least two user teams comprises comparing a performance of a first one of the user teams to performances of a plurality of the user teams.

8. The game system of claim 1, wherein the host platform is operable to receive a request from a first user that one or more real team units on the first user team be removed from the first user team in comparing the performance of the first user team to the performance of a second user team.

9. The game system of claim 1, wherein at least one user team has a roster comprising the real team units of the at least one user team and wherein, for the comparison, the at least one user team comprises an active lineup, the active lineup comprising a subset of the real team units on the roster.

10. The game system of claim 1, wherein the host platform is operable to execute a transfer of at least one real team unit of a first user team to a second user team.

11. The game system of claim 1, wherein the host platform enables electronic communication between users, and wherein the game system is operable to reward at least one user based on a quality assessment of the electronic communication.

12. The game system of claim 1, wherein the host platform is operable to reward at least one user based on the performance of the at least one user's user team.

13. The game system of claim 1, wherein the host platform is operable to reward at least one user based on ambassador activities of the at least one user.

14. The game system of claim 1, wherein the comparison comprises comparing performance of a first user team during post-season play of the real teams to a performance of a second user team during the post-season play.

15. The game system of claim 14, wherein the comparison further comprises awarding at least one point for a real team unit appearing in a post season game.

16. The game system of claim 14, wherein the comparison further comprises awarding at least one point for a real team unit winning a post season game.

17. The game system of claim 14, wherein the real team units comprise college football teams and wherein the comparison comprises awarding at least one point for a real team unit winning a post season game, awarding at least one point for a real team unit appearing in a Bowl Championship Series bowl game, awarding at least one point for a real team unit winning a Bowl Championship Series bowl game, and awarding at least one point for a real team unit winning the Bowl Championship Series.

18. The game system of claim 1, wherein the host platform is operable to send at least one notification to at least one user, the at least one notification comprising a notification of an impending draft.

19. The game system of claim 1, wherein the host platform is operable to send at least one notification to at least one user, the at least one notification comprising a notification of a trade request.

20. The game system of claim 1, wherein the host platform is operable to send at least one notification to at least one user, the at least one notification comprising a reminder to the at least one user to establish an active lineup comprising a subset of the real team units on a roster of the at least one user.

21. The game system of claim 1, wherein the host platform is operable to reward at least one user based on at least one predetermined criteria.

22. The game system of claim 21, wherein the reward comprises a virtual reward.

23. The game system of claim 21, wherein the reward comprises virtual goods.

24. The game system of claim 21, wherein the reward comprises a financial reward.

25. A non-transitory computer readable medium having embodied thereon a program, the program being executable by a computing device for performing a method for operating a game, the method comprising:
receiving user team creation requests from a plurality of users,
presenting the users with a plurality of real team units,
accepting from the users selections of a plurality of the real team units as members of the user teams, and
comparing performances of at least two user teams.

26. A method of operating a game, comprising:
receiving, at a host platform, user team creation requests of a plurality of users, the requests being received from a plurality of user stations,
presenting, on at least one graphical user interface, a plurality of real team units for selection by the plurality of users,
accepting, at the host platform and from the plurality of user stations, selections of a plurality of the real team units as members of respective user teams,
comparing, at the host platform performances of at least two user teams.
